(19) United States
(12) Patent Application Publication
(10) Pub. No.: US 2025/0045846 A1
(43) Pub. Date: Feb. 6, 2025

(54) Implementing Machine-Learned Models to Perform a Construction Project Associated with a Structure

(71) Applicant: Fluke Corporation, Everett, WA (US)

(72) Inventors: Samuel J. Strickling, Everett, WA (US); Alex Chillman, Everett, WA (US)

(21) Appl. No.: 18/790,839

(22) Filed: Jul. 31, 2024

Related U.S. Application Data
(60) Provisional application No. 63/517,091, filed on Aug. 1, 2023.

(51) Int. Cl. G06Q 50/08; G06Q 10/0637; G06V 10/70; G06V 20/10

(52) U.S. Cl. CPC G06Q 50/08; G06Q 10/0637; G06V 10/70; G06V 20/176

(57) ABSTRACT

A method for performing a project with respect to a structure includes obtaining, by a computing device comprising one or more processors, context data descriptive of a project associated with a structure, the context data including textual data including one or more codes associated with the structure; implementing, by the computing device, one or more first machine-learned models to generate one or more project performance operations for the project based on the context data, wherein the one or more project performance operations include operations for completing the project in compliance with the one or more codes; and providing, by the computing device, the one or more project performance operations as an output.

### CROSS-REFERENCE TO RELATED APPLICATIONS

This application is based on and claims priority to U.S. Provisional Application 63/517,091 having a filing date of Aug. 1, 2023, which is incorporated by reference herein in its entirety for all purposes.

### FIELD

The disclosure relates generally to artificial intelligence (AI) and machine learning (ML) technologies and, more specifically, to structure or building safety and construction management, where AI and ML models can be used to facilitate the identification of applicable codes, to inspect structures following the completion of project operations or tasks, and to efficiently allocate resources for completing project operations or tasks.

### BACKGROUND

Building codes are a set of regulations and standards that govern the design, construction, and occupancy of buildings. They can be put in place by local, regional, or national governments to ensure the safety, health, and welfare of the public, as well as to promote the structural integrity and functionality of buildings. The specific requirements and details of building codes can vary depending on the jurisdiction and the type of building being constructed or the type of work being performed with respect to the building.

The task of identifying and understanding the applicable codes is a significant challenge in the technical aspect. It often involves sifting through extensive code books and standards documents, which can be time-consuming and laborious. Not only does this process require considerable effort and resources, but it is also prone to errors due to the complexity and volume of the codes.

Furthermore, the ever-changing nature of these codes presents another technical problem. Standards are frequently updated or modified, which necessitates regular monitoring and understanding of these changes. Failure to stay up to date with the current codes may result in non-compliance, which could lead to failed inspections, safety hazards, or even legal repercussions.

Additionally, the interpretation of these codes can be technically challenging. Codes are often written in technical jargon, which may be difficult to understand for those without specific expertise.

Therefore, it is difficult for even trained professionals to effectively and accurately identify, understand, and apply the relevant building codes for any given project. This issue is compounded by the need to stay current with changing standards and to navigate the complexity of technical language in these codes.

### SUMMARY

Aspects and advantages of embodiments of the disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example aspects of the disclosure include a computer-implemented method to perform a project with respect to a structure in a manner which can improve building safety. The computer-implemented method includes obtaining, by a computing device comprising one or more processors, context data descriptive of a project associated with a structure, the context data including textual data including one or more codes associated with the structure; implementing, by the computing device, one or more first machine-learned models to generate one or more project performance operations for the project based on the context data, wherein the one or more project performance operations include operations for completing the project in compliance with the one or more codes; and providing, by the computing device, the project performance operations as an output.

In some implementations, the context data further includes one or more images of the structure.

In some implementations, the one or more images are captured by a user, and the one or more project performance operations for the project are generated by the one or more first machine-learned models in response to the one or more images being captured by the user.

In some implementations, obtaining, by the computing device comprising the one or more processors, the context data descriptive of the project associated with the structure comprises: obtaining, by the computing device, project data that describes the project; identifying, by the computing device, the one or more codes that relate to the project based on the project data; and retrieving, by the computing device, the one or more codes from a database.

In some implementations, the project data comprises location data associated with the structure and a textual description of the project.

In some implementations, identifying, by the computing device, the one or more codes that relate to the project based on the project data comprises implementing, by the computing device, one or more second machine-learned models to identify, based on the project data, the one or more codes that relate to the project.

In some implementations, the method further comprises obtaining, by the computing device, one or more images of the structure following performance of the project performance operations; implementing, by the computing device, one or more second machine-learned models to generate one or more inspection outcomes based on the one or more images of the structure; and providing, by the computing device, the one or more inspection outcomes as another output.

In some implementations, the one or more inspection outcomes indicate one or more aspects of the structure that satisfy or do not satisfy the one or more codes.

In some implementations, the one or more inspection outcomes indicate a request for further information in association with one or more aspects of the structure that are not visible within the one or more images of the structure.

In some implementations, the request for further information includes outputting a request to a user to provide confirmation information associated with the one or more aspects of the structure that are not visible within the one or more images of the structure, and the method further comprises, in response to receiving the confirmation information, implementing, by the computing device, the one or more second machine-learned models to re-generate the one or more inspection outcomes based on the one or more images and the confirmation information.

In some implementations, the request for further information includes outputting a request to a user to capture one or more images of the one or more aspects of the structure that are not visible within the one or more images of the structure; and the method further comprises, in response to receiving the one or more images of the one or more aspects of the structure, implementing, by the computing device, the one or more second machine-learned models to re-generate the one or more inspection outcomes based on the one or more images of the structure and the one or more images of the one or more aspects of the structure.

In some implementations, the one or more inspection outcomes indicate a likelihood of passing an inspection according to the one or more codes associated with the structure.

In some implementations, the method includes implementing, by the computing device, one or more third machine-learned models to detect one or more objects in the one or more images of the structure, and the one or more second machine-learned models generate the one or more inspection outcomes based on the one or more images of the structure and the one or more objects detected in the one or more images of the structure.

In some implementations, the method includes obtaining, by the computing device, one or more images of the structure; and implementing, by the computing device, one or more second machine-learned models to detect one or more objects in the one or more images of the structure, and the one or more first machine-learned models generate the one or more project performance operations for the project based on the context data including the one or more codes, the one or more images of the structure, and the one or more objects detected in the one or more images of the structure.

In some implementations, obtaining, by the computing device comprising the one or more processors, the context data descriptive of the project associated with the structure comprises: obtaining, by the computing device, project data that describes the project. The method can further include implementing, by the computing device, one or more second machine-learned models to match the project with an operator from among a plurality of operators, based on the project data.

Example aspects of the disclosure include a computing device comprising one or more memories configured to store instructions; and one or more processors configured to execute the instructions to perform operations. The operations can include: obtaining context data descriptive of a project associated with a structure, the context data including textual data including one or more codes associated with the structure; implementing one or more first machine-learned models to generate one or more project performance operations for the project based on the context data, wherein the one or more project performance operations include operations for completing the project in compliance with the one or more codes; and providing the one or more project performance operations as an output.

In some implementations, obtaining the context data descriptive of the project associated with the structure comprises: obtaining project data that describes the project, and the operations further comprise: implementing one or more second machine-learned models to identify the one or more codes that relate to the project based on the project data.

In some implementations, the operations further comprise: implementing one or more third machine-learned models to match the project with an operator from among a plurality of operators, based on the project data.

In some implementations, the operations further comprise: capturing one or more first images of the structure; implementing one or more fourth machine-learned models to detect one or more objects, structures, or materials within the one or more first images; and implementing the one or more first machine-learned models to generate the one or more project performance operations for the project is further based on the one or more first images of the structure and the one or more objects, structures, or materials detected by the one or more fourth machine-learned models within the one or more first images.

In some implementations, the operations further comprise: capturing one or more second images of the structure following completion of the one or more project performance operations; implementing the one or more fourth machine-learned models to detect one or more objects, structures, or materials within the one or more second images; implementing one or more fifth machine-learned models to generate one or more inspection outcomes based on the context data including the one or more codes and the project data, the one or more second images of the structure, and the one or more objects, structures, or materials detected by the one or more fifth machine-learned models within the one or more second images; and providing the one or more inspection outcomes as another output.

The computing device may be configured to execute instructions to perform operations associated with any of the other aspects and operations of the computer-implemented methods as described herein.

Example aspects of the disclosure include a non-transitory computer readable medium storing instructions which, when executed by a processor, cause the processor to perform operations for performing a project, the operations comprising: obtaining context data descriptive of a project associated with a structure, the context data including textual data including one or more codes associated with the structure; implementing one or more first machine-learned models to generate one or more project performance operations for the project based on the context data, wherein the one or more project performance operations include operations for completing the project in compliance with the one or more codes; and providing the one or more project performance operations as an output.

The non-transitory computer-readable medium may store additional instructions to execute any of the other aspects and operations of the computing devices, computing systems, and computer-implemented methods as described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended drawings, in which:

FIG. 1A depicts a block diagram of an example data flow for generating project performance operations according to example embodiments of the disclosure.

FIG. 1B depicts a block diagram of an example data flow for generating inspection outcomes according to example embodiments of the disclosure.

FIG. 2A depicts a block diagram of an example computing system according to example embodiments of the disclosure.

FIG. 2B depicts a block diagram of an example computing system according to example embodiments of the disclosure.

FIG. 3 is an example flow diagram of a process for performing project operations with respect to a structure, according to example embodiments of the disclosure.

FIG. 4 is an example diagram which depicts an example exchange of information involving one or more machine-learned models, according to example embodiments of the disclosure.

FIGS. 5A through 5I are example user interface screens which can be presented to a user for performing a project with respect to a structure, according to example embodiments of the disclosure.

FIGS. 6A through 6F are example user interface screens which can be presented to a user for performing a project with respect to a structure, according to example embodiments of the disclosure.

FIGS. 7A and 7B are example computer-implemented methods for performing a project with respect to a structure, according to example embodiments of the disclosure.

FIG. 8 is a flow chart diagram illustrating an example method for training a machine-learned model, according to example embodiments of the disclosure.

FIG. 9 is a block diagram of an example sequence processing model, according to example embodiments of the disclosure.

FIG. 10 is a block diagram of an example implementation of a multi-modal sequence processing model, according to example embodiments of the disclosure.

FIG. 11 is an example training flow for training a machine-learned model, according to example embodiments of the disclosure.

FIG. 12 is a block diagram of an example networked computing system, according to example embodiments of the disclosure.

Reference numerals that are repeated across plural figures are intended to identify the same features in various implementations.

### DETAILED DESCRIPTION

Generally, the disclosure is directed to computer systems and methods that can be implemented to perform a project with respect to a structure which can improve building safety through the use of artificial intelligence, computer vision, large language, and machine learning models. One example method can include obtaining context data about a project associated with a structure (e.g., a building, an electrical component, etc.). For example, the context data can include textual data such codes associated with the project and/or structure. As another example, the context data can also include images of the project site and/or structure taken by a user. The context data is then processed with one or more machine-learned code compliance models to generate project performance operations that can ensure the project's completion in compliance with the codes. The performance operations can then be provided as an output.

In some implementations, the disclosed methods can also include obtaining project data that describes the project, identifying the relevant codes based on the project data, and retrieving these codes from a database. For example, the project data may include location data and a textual description of the project. The identifying process may involve processing the project data with one or more machine-learned code identification models.

A project can be any new creation, modification, restoration, or other construction relating to a structure (e.g., a commercial building, a residential home, etc.). As used herein, a structure does not necessarily refer to a single physical structure but can refer generally to a physical site containing one or multiple physical structures, which may or may not have the purpose of housing persons. For example, a photovoltaic array or an electrical system may be considered a structure.

In some implementations, the disclosed methods can also include obtaining images of the structure after the performance of the project operations and processing these images with one or more machine-learned code inspection models to generate inspection outcomes. These inspection outcomes identify to what extent aspects of the structure either satisfy or do not satisfy the codes applicable to the project or can identify aspects of the structure that are not visible within the images and for which further information is needed to make a determination regarding whether the project satisfies codes associated with the project and/or structure. For example, further inspection may be needed (e.g., further imagery, audio, or multi modal sources) and/or a confirmation from an operator may be obtained to ensure that a particular project performance operation is performed in compliance with the codes applicable to the project and/or structure.

Furthermore, in some implementations, the disclosed methods can also include obtaining project data descriptive of the building project and matching the project with an operator (e.g., human operator, machine operator such as a robot or autonomous machine, etc.) based on this data.

The disclosed computer systems and methods introduce several technical effects and benefits related to project safety and completing projects in an efficient manner that complies with codes applicable to the project and/or structure. The application of artificial intelligence and machine learning models brings about significant improvements in the process of identifying and understanding codes, matching suitable operators to a particular project, verifying that codes are being complied with during and after the completion of project performance operations, etc.

In particular, the disclosed methods and computing systems provide technical efficiency in ensuring the project's completion in compliance with the applicable codes and reduces the risk of human error in interpreting and applying the codes. For example, the use of the one or more machine-learned code identification models ensures a reliable, repeatable, and accurate identification of the applicable codes. This eliminates the need for manual searching and interpretation of extensive code books which may be outdated, and allows for more accurate and faster code identification.

Furthermore, the disclosed methods and computing systems can obtain images of the project site, materials, tools, structure, etc. during and after the performance of the project performance operations and can process these images with one or more computer vision algorithms and/or one or more machine-learned code inspection models. The one or more computer vision algorithms can detect objects, tools, materials, structures, etc., from the images. The one or more machine-learned code inspection models can generate inspection outcomes based on the obtained images and/or based on the detected objects, tools, materials, structures, etc., which represents another technical improvement. This automated inspection process identifies aspects of the structure that either satisfy or do not satisfy the codes, or aspects that are not visible within the images that may need further inspection or confirmation from an operator. This allows for a more thorough and objective inspection of the structure, as opposed to traditional manual inspections which can on occasion include oversights and subjectivity.

As another example, the disclosed methods and computing systems can also obtain project data descriptive of the project and match the project (e.g., via a matching engine which may include one or more machine-learned models) with an operator based on the project data. This automated matching process can efficiently allocate resources based on the specifics of the project, thereby improving the operational efficiency in project management.

With reference now to the drawings, example implementations of the disclosure will be described in further detail.

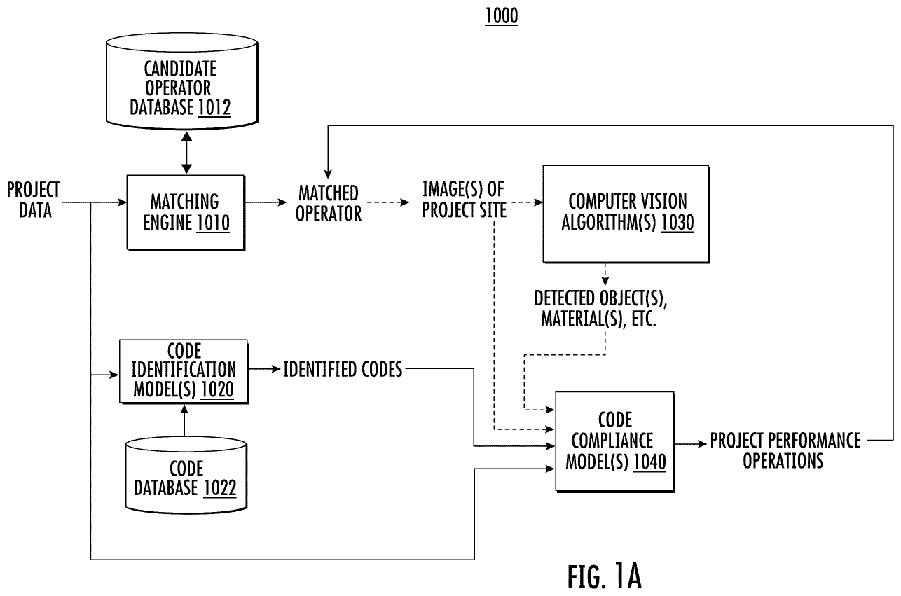

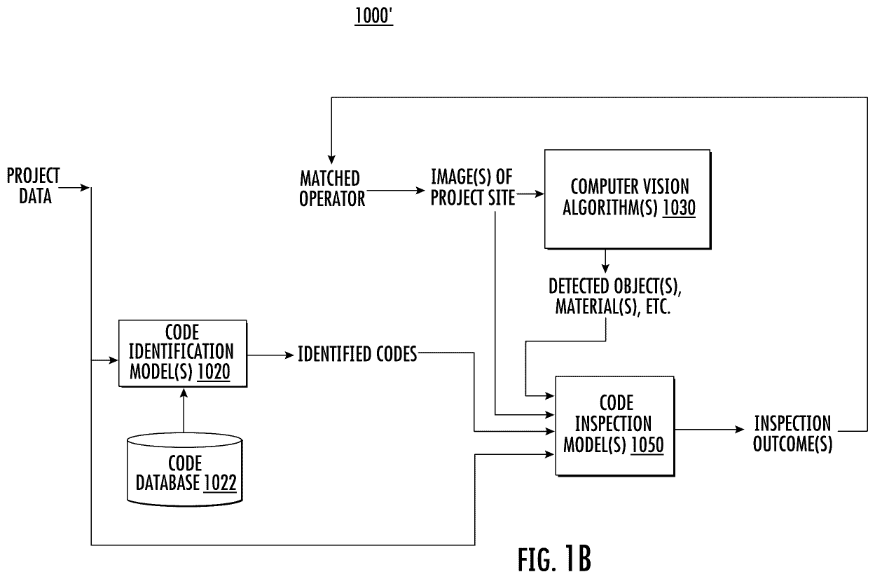

FIGS. 1A and 1B illustrate data flow examples enacted by one or more computer systems to execute example implementations of one of the disclosed methods for performing project operations with respect to a structure.

Referring to FIG. 1A, the computing system 1000 can include a matching engine 1010 (e.g., one or more first machine-learned models), one or more code identification models 1020 (e.g., one or more second machine-learned models), one or more computer vision algorithms 1030 (e.g., one or more third machine-learned models), and one or more code compliance models 1040 (e.g., one or more fourth machine-learned models). Referring to FIG. 1B, the computing system 1000′ can include the one or more code identification models 1020, the one or more computer vision algorithms 1030, and one or more code inspection models 1050 (e.g., one or more fifth machine-learned models). In some implementations, the computing system 1000 and the computing system 1000′ can be part of the same computing system, where aspects of computing system 1000′ can be implemented to inspect a project after completion of project operations. Thus, computing system 1000 and computing system 1000′ can be combined as a single computing system.

Referring to FIG. 1A, the matching engine 1010 and the one or more code identification models 1020 are configured to receive project data. For example, the project data can include dispatch data which can include information regarding a project to be completed with respect to a structure (e.g., a building). For example, the project data can specify a building's location, which could be an address or a geolocation. For example, the project data can detail a building project to be undertaken at a building. For example, the building project can be an electrical installation or a repair project.

In some implementations, the computing system 1000 (e.g., the matching engine 1010 and the one or more code identification models 1020) can ingest dispatch notes through a scraping method that seeks key contextual words. These words may have been previously weighted using data relevant to the building trade. In some implementations, when certain key words are detected, they are extracted and compared to pre-established examples. If these words exhibit conviction beyond a preset threshold, they can be transferred into a model repository. For instance, the dispatch notes could include an address of a structure (e.g., a house, apartment building, commercial building, etc.), basic work description, and whether the project entails a new or replacement service. The dispatch notes can include information about the owner of the property (e.g., language(s) spoken, pets owned, information about family members, availability, etc.), preferences of the owner (e.g., preferred hours, preferred operators or contractors, etc.). The computing system 1000 (e.g., the one or more code identification models 1020) can consume the specific location of the project, construct or reference the Standard Operating Procedure (SOP) for similar work, and make an initial estimate or determination relating to the work location (interior or exterior).

The computing system 1000 (e.g., the one or more code identification models 1020) can be configured to add these keywords as modifiers to estimate or determine the codes that may be referenced when the operator arrives onsite. For instance, extracted data such as “Washington County, Residential, Add Breaker, 110V, interior wall” could be utilized by the computing system 1000, which may also incorporate some most common keywords (2nd order) like “dry wall, single story, NEC Code, and 1974” (the year the house was built).

In particular, the one or more code identification models 1020 can process the project data to identify a set of codes (e.g., building codes) that are relevant to the project. For example, the one or more code identification models 1020 can be configured to identify the set of codes from a code database 1022 based on the project data. The code database 1022 can store codes (e.g., building codes), regulations, laws, rules, etc., that are relevant or applicable to different kinds of projects for a particular jurisdiction (e.g., a city, county, state, country, etc.).

In an example, the computing system 1000 (e.g., the one or more code identification models 1020) can be configured to return relevant National Electrical Code (NEC) codes. For example, the one or more code identification models 1020 can be configured to output a textual summary describing the applicable codes for a particular project. An example textual summary for a particular structure or project may be: “Here are some of the relevant NEC codes that might be referenced for a sub-panel installation in a residential house in Washington County” followed by a list of relevant codes. Table 1 illustrates example NEC codes which could be output via the one or more code identification models 1020, for example.

TABLE 1
Article 110 - Requirements for Electrical Installations - This article provides general
requirements for electrical installations, including grounding, overcurrent protection, and
working space requirements.
Article 215 - Feeders - This article provides requirements for feeder conductors, including
ampacity, voltage drop, and installation methods.
Article 220 - Branch Circuit, Feeder, and Service Calculations - This article provides
requirements for calculating the load on a sub panel and sizing the feeder conductors and
overcurrent protection.
Article 225 - Outside Branch Circuits and Feeders - This article provides requirements for
outside branch circuits and feeders, including installation methods, grounding, and overcurrent
protection.
Article 250 - Grounding and Bonding - This article provides requirements for grounding and
bonding of electrical systems and equipment, including the sub panel and feeder conductors.
Article 310 - Conductors for General Wiring - This article provides requirements for
conductors used in electrical installations, including sizing, insulation, and installation
methods.

Accordingly, the one or more code identification models 1020 of the computing system 1000 can accurately predict and provide relevant codes, enhancing the efficiency and reliability of the building safety inspection process as well as enhancing the efficiency and reliability of performing a project safely and correctly by following appropriate codes, thereby avoiding the need to repeat work, avoid delays in project completion, etc.

According to another aspect, the computing system 1000 can process the project data with a matching engine 1010 to identify a suitable operator for the project. In some implementations, the operator can include a human operator or a machine operator (e.g., a robot, an autonomous machine, etc.). The matching engine 1010 can include one or more first machine-learned models, for example. The matching engine 1010 can select the suitable operator from a candidate operator database 1012 which includes a plurality of potential operators. In some implementations, inputs to the matching engine 1010 may include one or more of qualifications (e.g., license requirements) needed to complete the project based on the project data provided, time needed to perform the project, a timeline to perform the project, information about the owner of the property (e.g., demographic information, language(s) spoken, pets owned, information about family members, availability, etc.), preferences of the owner (e.g., preferred hours, preferred operators or contractors, etc.), proximity information relating to the operators, etc. Information about the candidate operators can also include qualification information (e.g., license information, standing, bond information, etc.), rating information from customers, area of expertise information, availability information, proximity information, languages spoken, etc. The matching engine 1010 can be configured to select an operator which is determined (e.g., estimated or predicted) to be an operator which is most likely to perform the project in compliance with codes associated with the project, meet customer expectations, complete the project within an acceptable timeframe, etc. In some implementations, the matching engine 1010 can be configured to select a plurality of operators when more than one operator is determined to be needed to complete the project.

In some implementations, the matching engine 1010 can be configured to transmit project details (e.g., the project data, necessary qualifications, scheduling information, project performance operations, permit information, cost information, etc.) to a user computing device associated with the selected operator(s). The selected operator(s) can provide an input to the user computing device accepting or denying the project. For example, in response to accepting the project, the computing system 1000 may be configured to transmit additional information relating to the project to the operator(s) (e.g., images of the project site, codes associated with the project and/or structure, project performance operations, etc.).

The computing system 1000 can treat the identified codes and the project data as a set of context data for the project. The computing system 1000 can process the context data with one or more code compliance models 1040 (one or more fourth machine-learned models) to generate one or more project performance operations. The project performance operations can outline one or more tasks to be undertaken to complete the project in compliance with the identified building codes. The project performance operations may include a series or sequence of tasks to be performed to complete the project. In some implementations, the tasks to be performed may be performed by a plurality of operators and one or more of the tasks may be performed in parallel with one or more other tasks. In some implementations, the project performance operations can be provided to the matching engine 1010 for determining the operator to perform the project.

The computing system 1000 can provide the project performance operations to the matched operator for execution by the operator. For example, the project performance operations may be presented for display to the operator via a user interface (graphical user interface) of a computing device which is associated with the operator. In some implementations, the computing device can include the computing system 1000 and/or computing system 1000′.

The project performance operations may be presented to the operator via the one or more code compliance models 1040. An example textual summary for a particular structure or project may be: “Here are the standard operating procedures for performing a sub-panel installation in a residential house in Washington County” followed by the sequence of project performance operations. Table 2 illustrates example project performance operations which could be output via the one or more code compliance models 1040, for example.

TABLE 2
1. Ensure that the sub panel is properly sized for the intended load.
2. Use appropriately sized wiring and conduit for the sub panel installation.
3. Ground the sub panel in accordance with NEC requirements.
4. Install a separate grounding electrode for the sub panel if required by the local
AHJ.
5. Ensure that all electrical connections are properly made and secured.
6. Label the sub panel and all circuits accordingly.
7. Have the sub panel installation inspected by the local AHJ before energizing the
system.

Accordingly, implementation of the one or more code compliance models 1040 can generate project performance operations that an operator can follow while complying with codes applicable to the project and/or structure.

In some implementations, the matched operator can capture images of the project site. This could be done initially or as part of an iterative feedback process. In some implementations, the images of the project site can be directly provided to the one or more code compliance models 1040 as an additional form of context data.

Alternatively, or additionally, the images of the project site can be provided to the one or more computer vision algorithms 1030 (e.g., one or more third machine-learned models). The one or more computer vision algorithms 1030 may be configured to process the images to identify (detect) certain objects, structures, or materials which are included in the images. The outputs of the one or more computer vision algorithms 1030 can optionally be supplied to the one or more code compliance models 1040 as context data. Accordingly, the computing system 1000 can be configured to incorporate the use of computer vision outputs to further refine recommendations. For example, if the photos taken by the operator (e.g., a field technician, a robot, etc.) display a multi-story building, the computing system 1000 can be configured to implement a trained machine-learned model (e.g., the one or more third machine-learned models) to identify the number of stories displayed in the images and the one or more code compliance models 1040 can identify additional codes that are applicable to buildings having the number of stories identified by the one or more third machine-learned models.

In some implementations, the one or more code compliance models 1040 can generate an updated set of project performance operations based on the additional context data. For example, if the field technician's photos show that the house is brick construction with a crawl space and a 200-amp service panel (which is different information from that previously assumed by the one or more code compliance models 1040 based on the original project data), the one or more code compliance models 1040 can be configured to refine the code suggestions to include those specific to brick construction and 200-amp service panels. The computing system 1000 might then output: “Considering the brick construction and 200-amp service panel of the building, please also refer to the following NEC codes for a safe and compliant installation.”

In some implementations, the computing system 1000 can also provide real-time feedback to the field technician. For example, if the technician captures an image of an electrical panel and the computing system 1000 may be configured to identify a potential code violation (e.g., via the one or more code inspection models 1050 described with respect to FIG. 1B), and the computing system 1000 can alert the technician immediately, allowing for immediate correction and thus reducing the risk of non-compliance, preventing possible injury, and avoiding associated fines or delays.

In some implementations, the one or more code identification models 1020 can generate an updated set of codes based on the additional context data. The computing system 1000 (e.g., the one or more code identification models 1020) can then output a refined set of codes (e.g., a refined set of NEC codes). Table 3 illustrates an example set of refined NEC codes which could be output via the one or more code compliance models 1040 based on the photos indicating additional information (e.g., a further input of the wall being brick).

TABLE 3
Article 110.12 - Mechanical Execution of Work - This article requires that electrical
installations be completed in a neat and workmanlike manner and in accordance with the NEC.
Article 210 - Branch Circuits - This article provides requirements for branch circuits, including
ampacity, overcurrent protection, and installation methods.
Article 215 - Feeders - This article provides requirements for feeder conductors, including
ampacity, voltage drop, and installation methods.
Article 250 - Grounding and Bonding - This article provides requirements for grounding and
bonding of electrical systems and equipment, including the sub panel and feeder conductors.
Article 300 - Wiring Methods - This article provides requirements for wiring methods,
including installation in or on walls, ceilings, and floors.
Article 334 - Nonmetallic-Sheathed Cable: Types NM, NMC, and NMS - This article provides
requirements for nonmetallic-sheathed cable, including ampacity and installation methods.
Article 800 - Communications Circuits - This article provides requirements for
communications circuits, including installation methods and separation from power circuits.

Further, the computing system 1000 (e.g., the one or more code compliance models 1040) may be configured to output a refined set of project performance operations. Table 4 illustrates an example set of refined project performance operations which could be output via the one or more code compliance models 1040 based on the photos indicating additional information (e.g., a further input of the wall being brick) and the updated codes.

TABLE 4
1. Turn off power to the area where the sub panel will be installed.
2. Select an appropriate location on the interior brick wall for the sub panel, ensuring that there
is adequate space for the panel and that it is easily accessible.
3. Install a wooden backer board to the wall using masonry anchors to provide a secure
mounting surface for the sub panel.
4. Run appropriately sized conduit from the main panel to the sub panel location. If
nonmetallic-sheathed cable (NM cable) is used instead of conduit, ensure that it is rated for the
appropriate ampacity and installation methods.
5. Install an appropriate sub panel that meets all NEC and local AHJ requirements for the
intended load, including ampacity, overcurrent protection, and grounding.
6. Install appropriately sized feeder conductors from the main panel to the sub panel, ensuring
that the voltage drop does not exceed NEC limits for the length of the run.
7. Install appropriate overcurrent protection for the feeder conductors, such as a circuit breaker
or fuses.
8. Connect the feeder conductors to the sub panel, ensuring that all connections are properly
made and secured.
9. Install an appropriate grounding system for the sub panel, including a grounding electrode
and grounding conductor in accordance with NEC and local AHJ requirements.
10. Label all circuits in the sub panel and ensure that they are appropriately sized and
protected.
11. Turn on power to the sub panel and test all circuits to ensure proper operation.

In some implementations, the computing system 1000 (e.g., the one or more code compliance models 1040) may be configured to output further instructions, notes, and/or guidance which are supplementary to the project performance operations. Table 5 illustrates an example set of further instructions which could be output (e.g., via the one or more code identification models 1020 and/or the one or more code compliance models 1040).

TABLE 5
1. Installation on an interior brick wall may require the use of specialized tools and equipment
to ensure proper mounting and installation.
2. A new run of over 100 feet may require careful consideration of voltage drop, conduit size,
and feeder conductor ampacity to ensure compliance with NEC requirements.
3. Using nonmetallic-sheathed cable (NM cable) instead of conduit may require additional
considerations for installation and protection.
4. The use of only 110 V may impact the size and type of sub panel and feeder conductors
required.

In some implementations, the one or more code identification models 1020 and/or the one or more code compliance models 1040 can be configured to further identify particular materials, tools, tests, etc., which are needed to perform the project performance operations associated with the project and/or structure.

FIG. 1B illustrates a workflow that is similar to FIG. 1A. However, whereas FIG. 1A shows operations to generate project performance operations that enable completion of the project, FIG. 1B shows how the system may enable inspection of the project after completion of one or more project performance operations or after completion of the project itself. In particular, in FIG. 1B, the context data (e.g., the images of the project site, the project data, and/or the identified codes are evaluated to determine whether the project complies with the relevant building codes.

Referring to FIG. 1B, in some implementations, upon completion of one or more tasks (project performance operations) or upon completion of the project, the one or more code inspection models 1050 may receive images associated with the project site. In some implementations, the one or more code inspection models 1050 may be configured to prompt the operator to provide (e.g., upload, share, copy, etc.) images of the project site to the computing system 1000′ (e.g., the one or more code inspection models 1050). In some implementations, the one or more code inspection models 1050 may be configured to automatically receive or retrieve images of the project site. For example, in some implementations the one or more code inspection models 1050 may reside at the computing device associated with the operator which captures the images of the project site.

The one or more code inspection models 1050 may be configured to generate inspection outcomes associated with the project and the structure. The inspection outcomes can identify aspects of the project and/or structure (e.g., a building, an electrical panel, an outlet, etc.) that either satisfy or do not satisfy the codes which are applicable to the project as identified by the one or more code identification models 1020. In some implementations, the one or more code inspection models 1050 can also generate information which indicates a likelihood that the project meets inspection criteria and will pass inspection. For example, the information which indicates the likelihood that the project meets inspection criteria and will pass inspection report can be expressed in percentage terms (e.g., a 95% likelihood of passing). However, other methods may be used to indicate the likelihood that the project meets inspection criteria and will pass inspection (e.g., a color coded indication such as green, yellow, and red, a rating on a scale of one to ten, etc.).

In some implementations, the inspection outcomes can identify aspects of the project and/or the structure (e.g., a building, an electrical panel, etc.) that are not visible within the images and which require further information (further inspection) and/or further images before a determination regarding whether the project and/or structure (e.g., a building, an electrical panel, etc.) either satisfies or does not satisfy the codes which are applicable to the project as identified by the one or more code identification models 1020. In some implementations, the computing system 1000′ can request the operator to confirm certain information related to the project which cannot be obtained via an image (e.g., an aspect of the structure cannot be captured via a camera) in order for the one or more code inspection models 1050 to generate the inspection outcomes associated with the project and the structure. For example, the computing system 1000′ may include a user interface by which the operator can provide or confirm the requested information. In some implementations, the computing system 1000′ can request the operator to capture a particular aspect of the structure (e.g., via a capturing device) which was not provided or was not visible in previously provided imagery, in order for the one or more code inspection models 1050 to generate the inspection outcomes associated with the project and the structure. For example, in response to receiving the additional imagery after outputting the request, the one or more code inspection models 1050 can be implemented to re-generate the inspection outcomes associated with the project and the structure. Thus, in some implementations, the one or more code identification models 1020 can utilize an antagonist model that has been trained on a rich dataset of inspection outcomes to scrutinize images for any potential flaws or defects. This antagonist model serves as an automated inspector, efficiently identifying potential issues that may not be readily apparent to the unaided human eye.

In an example, the images provided to the one or more code inspection models 1050 can be (automatically) analyzed to check for compliance with any and all relevant codes (e.g., NEC or other applicable codes) after the performance of a particular project performance operation. After this automated inspection, the computing system 1000′ can be configured to provide feedback regarding whether the project and/or structure satisfies one or more codes associated with the project and/or structure. In some implementations, the computing system 1000′ may be configured to prompt the operator to confirm the completeness of the project. In some implementations, the computing system 1000′ may be configured to prompt the operator to confirm whether the operator has completed capturing additional images of the project site or structure after the one or more code inspection models 1050 provides an output (the inspection outcomes) indicating that one or more aspects of the project and/or the structure are not visible. The feedback provided by the computing system 1000′ ensures a thorough and comprehensive inspection process that combines the strengths of both human and AI inspection techniques.

In addition, the one or more code inspection models 1050 can also generate a detailed report of the work done. This report can then be reviewed by the operator for verification, adding a layer of oversight while also further training and refining the machine-learned models described herein (e.g., the one or more code identification models 1020, the one or more code compliance models 1040, the one or more code inspection models 1050, the machine-learned models that may be associated with the matching engine 1010 and one or more computer vision algorithms 1030, etc.). This process can improve the performance of the machine-learned models described herein, as each model can learn from the feedback, captured images, and decisions of the operator.

The various machine-learned models described herein (e.g., the one or more code identification models 1020, the one or more code compliance models 1040, the one or more code inspection models 1050, the machine-learned models that may be associated with the matching engine 1010 and one or more computer vision algorithms 1030, etc.), can be created in a variety of ways. In some implementations, one or more of the machine-learned models can be pre-trained models. For example, a computing system (e.g., computing system 1000 and/or computing system 1000′) can be configured to train one or more of the machine-learned models by utilizing an existing Language Model (LLM) and directing the LLM towards a repository of readily available data and requesting that topics from the repository be accorded a stronger weighted bias. This method can swiftly shape a specific model or alias for the task in hand. Additionally, given that most of this data is in a common language, easily available, and has a large historical record, a new LLM and/or Convolutional Neural Network (CNN) can be created specifically for tasks in the desired field, for tasks directed to a particular type of project, etc.

Thus, the methods implemented via the computing system 1000 and/or computing system 1000′ significantly enhance the efficiency and reliability of the safety inspection process relating to the project and structure, by automating the identification and application of relevant codes using artificial intelligence and one or more machine-learned models. This reduces the risk of human error and allows for more thorough and accurate inspections, thereby improving project safety, avoiding delays, reducing costs, reducing resource consumption by avoiding having to repeat or redo work, etc.

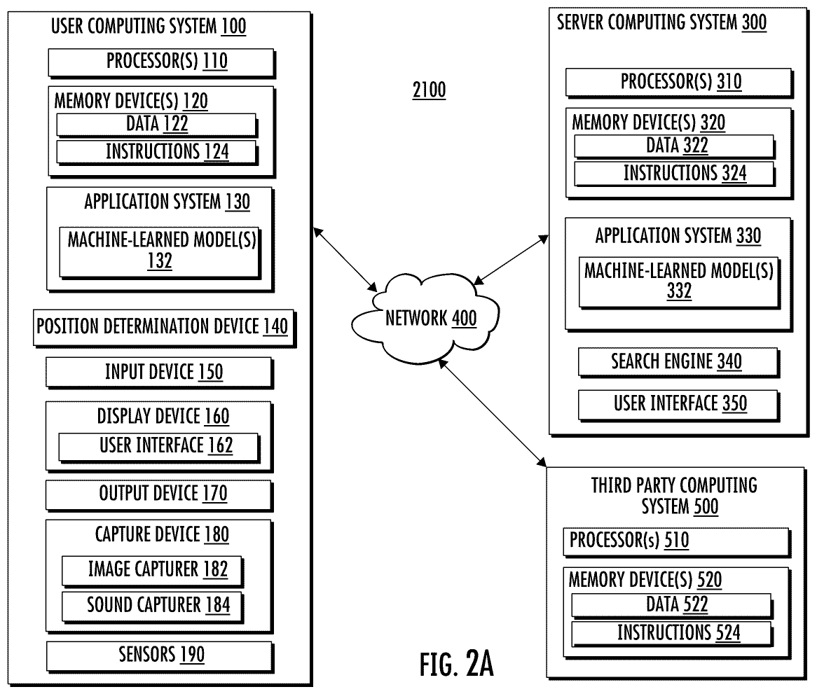

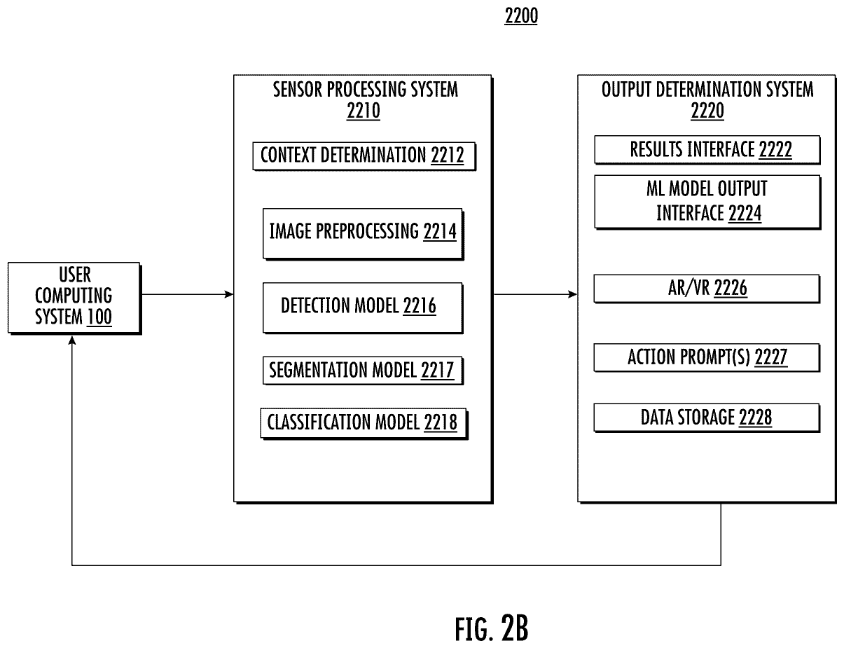

FIG. 2A depicts a block diagram of an example computing system 2100 according to example embodiments of the disclosure. The computing system 2100 includes a user computing system 100, a server computing system 300, and/or a third party computing system 500 that are communicatively coupled over a network 400.

The user computing system 100 can include any type of computing device, such as, for example, a personal computing device (e.g., laptop or desktop), a mobile computing device (e.g., smartphone or tablet), a gaming console or controller, a wearable computing device (e.g., augmented-reality goggles), an embedded computing device, or any other type of computing device. In some implementations, the user computing system 100 can be realized by a single computing device or can be realized by a plurality of computing devices. For example, the user computing system 100 can include a first computing device (e.g., a smartphone, wearable computing device, etc.) to capture images of a project site and/or structure and a second computing device (e.g., a laptop computer, a desktop computer, etc.) to receive the images and to determine the project performance operations based on the images. The user computing system 100 can correspond to and implement some or all of the operations implemented by computing system 1000 and computing system 1000′ described herein.

The server computing system 300 can include or otherwise be implemented by one or more server computing devices. In instances in which the server computing system 300 includes plural server computing devices, such server computing devices can operate according to sequential computing architectures, parallel computing architectures, or some combination thereof. The server computing system 300 can correspond to and implement some or all of the operations implemented by computing system 1000 and computing system 1000′ which are described herein.

The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the user computing system 100 and/or server computing system 300 may form part of an application system which can provide a tool via one or more machine-learned models for users to perform a project with respect to a structure, to determine whether operations performed to complete a project satisfy codes associated with the project, to determine an operator to perform the project, etc.

The user computing system 100 includes one or more processors 110, one or more memory devices 120, an application system 130, a position determination device 140, an input device 150, a display device 160, an output device 170, a capture device 180, and one or more sensors 190. The server computing system 300 may include one or more processors 310, one or more memory devices 320, an application system 330, a search engine 340, and a user interface 350. The third party computing system 500 may include one or more processors 510 and one or more memory devices 520.

For example, the one or more processors 110, 310, 510 can be any suitable processing device that can be included in a user computing system 100, server computing system 300, or third party computing system 500. For example, the one or more processors 110, 310, 510 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310, 510 can be a single processor or a plurality of processors that are operatively connected, for example in parallel.

The one or more memory devices 120, 320, 520 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320, 520 are not limited to the above description, and the one or more memory devices 120, 320, 520 may be realized by other various devices and structures as would be understood by those skilled in the art.

The one or more memory devices 120, 320, 520 can store data 122, 322, 522 and instructions 124, 324, 524 which are executed by the one or more processors 110, 310, 510 to cause the user computing system 100, server computing system 300, and third party computing system 500 to perform operations (e.g., operations associated with the methods described herein).

In some example embodiments, the user computing system 100 includes an application system 130. For example, the application system 130 may include a project management application. The application system 130 can include various other applications including document applications, text messaging applications, email applications, media (image, video, etc.) applications, dictation applications, virtual keyboard applications, browser applications, map applications, social media applications, navigation applications, etc.

In some implementations, the user computing system 100 can store or include one or more machine-learned models 132 which may be implemented to execute one or more aspects of applications associated with the application system 130. For example, the one or more machine-learned models 132 can include the one or more code identification models 1020, the one or more code compliance models 1040, the one or more code inspection models 1050, the machine-learned models that can be associated with the matching engine 1010 and the one or more computer vision algorithms 1030, etc. For example, the one or more machine-learned models 132 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, transformer neural networks, or other forms of neural networks.

In some implementations, the one or more machine-learned models 132 can be received from the server computing system 300 over network 400, stored in the one or more memory devices 120, and then used or otherwise implemented by the one or more processors 110. In some implementations, the user computing system 100 can implement multiple parallel instances of a single machine-learned model among the one or more machine-learned models 132 (e.g., to perform parallel machine-learned model processing across multiple instances of input data and/or detected features).

More particularly, the one or more machine-learned models 132 may include one or more detection models, one or more classification models, one or more segmentation models, one or more augmentation models, one or more generative models, one or more natural language processing models, one or more optical character recognition models, and/or one or more other machine-learned models. The one or more machine-learned models 132 can include one or more transformer models. The one or more machine-learned models 132 may include one or more neural radiance field models, one or more diffusion models, and/or one or more autoregressive language models.

The one or more machine-learned models 132 may be utilized to detect one or more object features. The detected object features may be classified and/or embedded. The classification and/or the embedding may then be utilized to perform a search to determine one or more search results. Additionally, or alternatively, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 132 can process image data, text data, audio data, and/or latent encoding data to generate output data that can include image data, text data, audio data, and/or latent encoding data. The one or more machine-learned models 132 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

In some example embodiments, the user computing system 100 includes a position determination device 140. Position determination device 140 can determine a current geographic location of the user computing system 100 and communicate the geographic location to the server computing system 300 over network 400. The position determination device 140 can be any device or circuitry for analyzing the position of the user computing system 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the user computing system 100. For example, in some implementations the project management application and the one or more machine-learned models 132 may be configured to utilize position information determined by the position determination device 140 to monitor or track a position of the user (e.g., in conjunction with images of the project site and/or structure captured by capture device 180).

The user computing system 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the project management application and implementing the one or more machine-learned models 132, for capturing an image via the capture device 180, for providing feedback to the project management application, for communicating with other users, for accepting or declining suggestions or recommendations provided by the user computing system 100 with respect to performing operations associated with the project, with respect to codes that are satisfied or not satisfied, with respect to operators selected to perform the project, etc.

The user computing system 100 may include a display device 160 which displays information viewable by the user (e.g., via a user interface screen provided via user interface 162). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the user computing system 100 to display information to a user relating to the performance of an operation for performing the project (e.g., applicable codes, instructions relating to performing a project performance operation, etc.), relating to feedback or guidance for performing an operation of the project, etc. The user interface 162 can be configured to receive inputs and/or provide data for display (e.g., image data, text data, audio data, one or more user interface elements, an augmented-reality experience, a virtual reality experience, and/or other data for display). The user interface 162 may be associated with one or more other computing systems (e.g., the server computing system 300 and/or the third party computing system 500). In some implementations, the user interface 162 can include a viewfinder interface, a search interface, a generative model interface, a social media interface, and/or a media content gallery interface. The display device 160 can be configured to provide, for presentation to a user, one or more user interface screens via the user interface 162 having user interface elements which are selectable by the user. The user interface elements which are selectable by the user can be configured to confirm the completion of a project performance operation, confirm the completion of the project, confirm the completion of capturing images of the project site and/or structure, provide feedback regarding the performance of the one or more machine-learned models 132, etc.

The user computing system 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to performing project performance operations, relating to whether codes associated with completing the project are satisfied, and/or for providing feedback or instructions (guidance) to a user regarding performing project performance operations.

The user computing system 100 may include a capture device 180 that is capable of capturing media content (e.g., photos, videos, etc.), according to various examples of the disclosure. For example, the capture device 180 can include an image capturer 182 (e.g., a camera) which is configured to capture images (e.g., photos, videos, etc.). For example, the image capturer 182 can include one or more cameras having an imaging sensor (e.g., a complementary metal-oxide-semiconductor (CMOS) or charge-coupled device (CCD)) to capture, detect, or recognize objects, materials, and the like, at a project site or structure. For example, the capture device 180 can include a sound capturer 184 (e.g., a microphone) which is configured to capture sound or audio (e.g., an audio recording). The media content captured by the capture device 180 may be transmitted to one or more of the server computing system 300 and the third party computing system 500, for example, via network 400. For example, in some implementations, content which is captured by the capture device 180 may be provided as an input to the one or more machine-learned models described herein to determine applicable codes associated with the project and/or structure, to determine an appropriate operator to perform the project, to determine objects and/or materials associated with the project and/or structure, to determine project performance operations, to determine whether applicable codes associated with the project and/or structure are satisfied, to provide feedback or instructions (guidance) to a user regarding the project performance operations, etc.

The user computing system 100 may include one or more sensors 190. The one or more sensors 190 may be housed in a housing component that houses the one or more processors 110, the one or more memory devices 120, and/or one or more hardware components, which may store, and/or cause to perform, one or more software packets. For example, the one or more sensors 190 may include an inertial measurement unit which includes one or more accelerometers and/or one or more gyroscopes, one or more magnetometers, one or more proximity sensors, one or more Hall effect sensors, one or more infrared sensors, one or more LIDAR sensors, one or more biological sensors (e.g., a heart rate sensor, a pulse sensor, a retinal sensor, and/or a fingerprint sensor), one or more touch sensors (e.g., a conductive touch sensor and/or a mechanical touch sensor), etc. The one or more accelerometers may be used to capture motion information with respect to the user computing system 100. The one or more gyroscopes may also be used additionally or alternatively to capture motion information with respect to the user computing system 100. The one or more sensors 190 may include sensors that can be used to complete the project or determine whether a project performance operation is completed satisfactorily. For example, the one or more sensors 190 may include sensors such as sensors to measure a temperature, sensors to measure pressure, sensors to measure electrical characteristics, sensors to measure the presence of gas or leaks, etc.

In some implementations, the image capturer 182 and/or sensors 190 may be configured to capture image data descriptive of the environment, data descriptive of the project, data descriptive of the structure, etc. Additionally, and/or alternatively, the image data may be obtained and uploaded from other user devices (e.g., third party computing system 500) that may be specialized for data obtainment or generation.

Referring again to the server computing system 300, in some example embodiments, the server computing system 300 includes an application system 330. For example, the application system 330 may include a project management application. The application system 330 can include various other applications including document applications, text messaging applications, email applications, media (image, video, etc.) applications, dictation applications, virtual keyboard applications, browser applications, map applications, social media applications, navigation applications, etc. In some implementations the server computing system 300 can store or include one or more machine-learned models 332 which may be part of the application system 330. The server computing system 300 can communicate with the user computing system 100 according to a client-server relationship. For example, the one or more machine-learned models 332 can be implemented by the server computing system 300 as a portion of a web service (e.g., a viewfinder service, a visual search service, an image processing service, an ambient computing service, and/or an overlay application service). Thus, the one or more machine-learned models 132 can be stored and implemented at the user computing system 100 and/or the one or more machine-learned models 332 can be stored and implemented at the server computing system 300.

As described above, the server computing system 300 can store or otherwise include the one or more machine-learned models 332 which can be part of application system 330. For example, the one or more machine-learned models 332 can be or can otherwise include various machine-learned models which are the same as the one or more machine-learned models 132. Example machine-learned models include neural networks or other multi-layer non-linear models. Example neural networks include feed forward neural networks, deep neural networks, recurrent neural networks, and convolutional neural networks.

Additionally, and/or alternatively, the server computing system 300 can include and/or be communicatively connected with a search engine 340 that may be utilized to crawl one or more databases (and/or resources). The search engine 340 can process data from the user computing system 100, the server computing system 300, and/or the third party computing system 500 to determine one or more search results associated with the input data. The search engine 340 may perform a term based search, label based search, Boolean based searches, image search, embedding based search (e.g., nearest neighbor search), multimodal search, and/or one or more other search techniques.

The server computing system 300 may store and/or provide one or more user interfaces 350 for obtaining input data and/or providing output data to one or more users. The one or more user interfaces 350 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

In some implementations, the user computing system 100 and/or the server computing system 300 can train the one or more machine-learned models 132 and/or 332 via interaction with the third party computing system 500 that is communicatively coupled over the network 400. The third party computing system 500 can be separate from the server computing system 300 or can be a portion of the server computing system 300. Alternatively, and/or additionally, the third party computing system 500 may be associated with one or more web resources, one or more web platforms, one or more other users, and/or one or more contexts. In some implementations, the third party computing system 500 includes or is otherwise implemented by one or more server computing devices.

The machine-learned models described herein may be used in a variety of tasks, applications, and/or use cases.

In some cases, the input to the machine-learned models includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that the region depicts an object of interest. As another example, the image processing task can be image segmentation, where the image processing output defines, for each pixel in the one or more images, a respective likelihood for each category in a predetermined set of categories. For example, the set of categories can include a foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system 100 may include a number of applications (e.g., applications 1 through N). Each application may include its own respective machine learning library and machine-learned model(s). For example, each application can include one or more machine-learned models. Example applications include a project management application as described herein, a text messaging application, an email application, a dictation application, a virtual keyboard application, a browser application, a social media application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 100 can include a number of applications (e.g., applications 1 through N). Each application may be in communication with a central intelligence layer. Example applications include a project management application as described herein, a text messaging application, an email application, a dictation application, a virtual keyboard application, a browser application, a social media application, etc. In some implementations, each application can communicate with the central intelligence layer (and model(s) stored therein) using an API (e.g., a common API across all applications).

The central intelligence layer can include a number of machine-learned models. For example, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the user computing system 100.

The central intelligence layer can communicate with a central device data layer. The central device data layer can be a centralized repository of data for the user computing system 100. The central device data layer may communicate with a number of other components of the user computing system 100, such as, for example, one or more sensors, a context manager, a device state component, and/or additional components. In some implementations, the central device data layer can communicate with each device component using an API (e.g., a private API).

FIG. 2B depicts a block diagram of an example computing system 2200 according to example embodiments of the disclosure. In particular, the example computing system 2200 can include one or more computing devices that are part of or correspond to user computing system 100 and/or are part of or correspond to server computing system 300. In some implementations, the example computing system 2200 can include one or more computing devices that are external to the user computing system 100 and the server computing system 300.

As illustrated in FIG. 2B, the user computing system 100 can be utilized to obtain, and/or generate, one or more datasets that can be processed by a sensor processing system 2210 and/or an output determination system 2220. In some implementations, the sensor processing system 2210 and/or the output determination system 2220 can be part of or correspond to user computing system 100 and/or are part of or correspond to server computing system 300. In some implementations, the sensor processing system 2210 and/or the output determination system 2220 can be external to the user computing system 100 and the server computing system 300.

For example, the sensor processing system 2210 and output determination system 2220 may be implemented via the user computing system 100, server computing system 300, and/or third party computing system 500 in association with one or more machine-learned models to perform operations described herein regarding performing a project, performing project performance operations, matching a project with an operator, determining codes applicable to a project and/or structure, detecting objects, materials, structures, etc. within images, determining inspection outcomes, etc. In some implementations, the sensor processing system 2210 and/or the output determination system 2220 can be implemented by the user computing system 100, server computing system 300, and/or third party computing system 500 to process project data, determine context data associated with the project data, process image data associated with the project and/or structure, and to provide output information relating to the project and/or structure (e.g., object identification results, inspection results, feedback information, etc.).

In some implementations, the sensor processing system 2210 and/or the output determination system 2220 can provide feedback or information to a user pertaining to features in the one or more datasets. The one or more datasets can include image data, text data, audio data, multimodal data, latent encoding data, etc. The one or more datasets may be obtained via one or more sensors associated with the user computing system 100 (e.g., the one or more sensors 190). Additionally, and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The user computing system 100 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 2210. The sensor processing system 2210 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 2212, which may determine a context associated with one or more content items. The context determination block 2212 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 2210 may include an image preprocessing block 2214. The image preprocessing block 2214 may be utilized to adjust one or more values of an obtained and/or received image to prepare the image to be processed by one or more machine-learned models and/or one or more search engines. The image preprocessing block 2214 may resize the image, adjust saturation values, adjust resolution, strip and/or add metadata, and/or perform one or more other operations.

In some implementations, the sensor processing system 2210 can include one or more machine-learned models, which may include one or more detection models 2216, one or more segmentation models 2217, one or more classification models 2218, and/or one or more other machine-learned models (e.g., one or more embedding models). For example, the sensor processing system 2210 may include one or more detection models 2216 that can be utilized to detect particular features in the processed dataset. In particular, one or more images can be processed with the one or more detection models 2216 to generate one or more bounding boxes associated with detected features in the one or more images.

Additionally, and/or alternatively, the one or more segmentation models 2217 can be utilized to segment one or more portions of the dataset from the one or more datasets. For example, the one or more segmentation models 2217 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 2218 can be utilized to process image data, text data, audio data, latent encoding data, multimodal data, and/or other data to generate one or more classifications. The one or more classification models 2218 can include one or more image classification models, one or more object classification models, one or more text classification models, one or more audio classification models, and/or one or more other classification models. The one or more classification models 2218 can process data to determine one or more classifications.

The output(s) of the sensor processing system 2210 can then be processed with an output determination system 2220 to determine one or more outputs to provide to a user. The output determination system 2220 may include heuristic based determinations, machine-learned model based determinations, user selection based determinations, and/or context based determinations.

The output determination system 2220 may determine how and/or where to provide the one or more results in a results interface 2222. Additionally, and/or alternatively, the output determination system 2220 may determine how and/or where to provide the one or more machine-learned model outputs in a machine-learned model output interface 2224. In some implementations, the one or more results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally, and/or alternatively, data associated with the output(s) of the sensor processing system 2210 may be utilized to generate and/or provide an augmented-reality experience and/or a virtual-reality experience 2226. For example, the one or more obtained datasets may be processed to generate one or more augmented-reality rendering assets and/or one or more virtual-reality rendering assets, which can then be utilized to provide an augmented-reality experience and/or a virtual-reality experience 2226 to a user. The augmented-reality experience may render information associated with an environment into the respective environment. Additionally, and/or alternatively, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 2227 may be determined based on the output(s) of the sensor processing system 2210. The one or more action prompts 2227 may then be provided to the user via one or more selectable user interface elements. In response to a selection of the one or more selectable user interface elements, a respective action of the respective action prompt may be performed (e.g., a search may be performed, an application programming interface may be utilized, and/or another application may be opened).

In some implementations, the one or more datasets and/or the output(s) of the sensor processing system 2210 may be stored based on a data storage block 2228 determination.

The output(s) of the output determination system 2220 can then be provided to a user via one or more output components of the user computing system 100. For example, one or more user interface elements associated with the one or more outputs can be provided for display via a visual display of the user computing system 100.

The processes may be performed iteratively and/or continuously. One or more user inputs to the provided user interface elements may condition and/or affect successive processing loops.

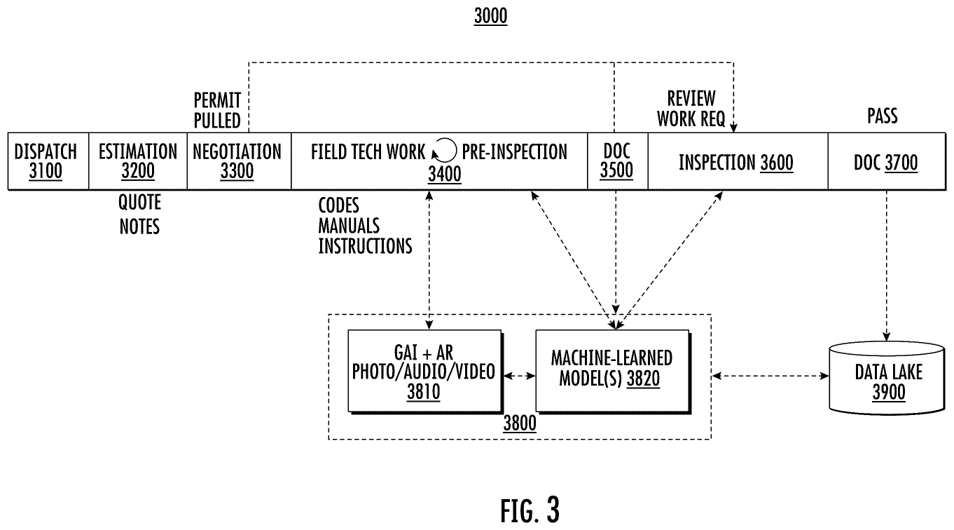

FIG. 3 is an example flow diagram of a process for performing project operations with respect to a structure, according to examples of the disclosure. The flow diagram 3000 of FIG. 3 can be implemented via a computing system which, as described herein, can correspond to the user computing system 100 and/or the server computing system 300, for example. In FIG. 3, the flow diagram 3000 includes the computing system receiving project data via a dispatch operation 3100. The dispatch operation 3100 can include a service call or request, a job ticket, etc., which can be in an electronic form (e.g., received through the Internet). For example, the project data can include dispatch data which can include information regarding a project to be completed with respect to a structure (e.g., a building). For example, the project data can specify a building's location, which could be an address or a geolocation. For example, the project data can detail a building project to be undertaken at a building. For example, the building project can be an electrical installation or a repair project. An estimation operation 3200 may include the computing system determining various details (quote notes) concerning the project, including an estimated time to perform the project, estimated materials needed to perform the project, estimated costs, etc. A negotiation operation 3300 may include the computing system finalizing the project (e.g., with the customer, with government agencies, with contractors, etc.) and proceeding with scheduling the project, pulling permits as needed for the project, and any other administrative tasks which can be performed (e.g., automatically performed) via the computing system. In some implementations, the negotiation operation 3300 can also include implementing the matching engine 1010 to identify a suitable operator (or operators) for performing the project performance operations to complete the project, based on the project data, information regarding candidate operators, etc.

Field tech work and pre-inspection operation 3400 can include implementing one or more machine-learned models 3820 from an application system 3800. The one or more machine-learned models 3820 can correspond to the one or more machine-learned models 132 and/or the one or more machine-learned models 332 from FIG. 2A. For example, the field tech work and pre-inspection operation 3400 can implement the one or more machine-learned models 3820 (e.g., the one or more code identification models 1020) from the application system 3800 to identify codes which are applicable to the project and/or the structure associated with the project. Field tech work and pre-inspection operation 3400 can include implementing the one or more machine-learned models 3820 (e.g., the one or more code compliance models 1040) from the application system 3800 to identify project performance operations which are applicable to the project and/or the structure associated with the project (e.g., based on the project data, photos/video/audio relating to the project, etc.).

Field tech work and pre-inspection operation 3400 can include implementing a graphics, audio-visuals and interaction (GAI) based augmented reality (AR) system 3810 to capture imagery, video, and/or sound associated with the project and/or the structure associated with the project. Data received via GAI based AR system 3810 can be received via the operator, a property owner, or a third party and can provide additional information that can be utilized by the one or more machine-learned models 3820 to generate or update the codes applicable to the project and/or the structure associated with the project, to generate or update the project performance operations applicable to the project and/or the structure associated with the project, and to generate or update the inspection results (outcomes) applicable to the project and/or the structure associated with the project. In some implementations, the application system 3800 may prompt the operator to capture imagery, video, and/or sound associated with the project and/or the structure associated with the project. The GAI based AR system 3810 need not include an AR system and the imagery, video, and/or sound associated with the project and/or the structure associated with the project can be captured via non-AR computing devices.

In some implementations, as part of the field tech work and pre-inspection operation 3400, the application system 3800 can provide codes, manuals, instructions, and other information to the operator for performing the project performance operations.

Document operation 3500 can include an operator providing documentation to the application system 3800 regarding the project performance operations performed in association with completing the project. For example, the operator can electronically provide the documents (e.g., imagery, videos, audio, descriptive text regarding the project, selection of pre-configured user interface elements, etc.) to a local computing device (e.g., to user computing system 100) and/or uploaded to a remote computing device (e.g., to server computing system 300).

Inspection operation 3600 can include implementing the one or more machine-learned models 3820 (e.g., the one or more code inspection models 1050) from the application system 3800 to generate inspection outcomes associated with the project and the structure (e.g., based on the project data, applicable codes, photos/video/audio relating to the project, etc.). In some implementations, the inspection operation 3600 can also include inspection results provided by a supervisor and/or an official inspector (e.g., a city, county, state inspector, etc.). The inspection results can be provided electronically (e.g., through imagery, videos, audio, descriptive text regarding the project, selection of pre-configured user interface elements, etc.) to the application system 3800 which can be used to refine the one or more machine-learned models 3820. In some implementations, the inspection results can also be stored at a local computing device (e.g., to user computing system 100) and/or uploaded to a remote computing device (e.g., to server computing system 300).

Document operation 3700 can include an operator providing documentation to a data lake 3900 (e.g., a database) regarding the project, including information pertaining to the inspection outcome, project performance operations performed in association with completing the project, codes applicable to the project, operators involved in completing the project, etc. The information from the data lake 3900 can be used by the computing system to observe trends with respect to the performance of the project, with respect to inspection results, operator performance, etc. For example, the computing system can electronically provide the documents (e.g., which can be in the form of imagery, videos, audio, descriptive text regarding the project, selection of pre-configured user interface elements, etc.) to the data lake 3900. In some implementations, the information can also be stored at a local computing device (e.g., to user computing system 100) and/or uploaded to a remote computing device (e.g., to server computing system 300).

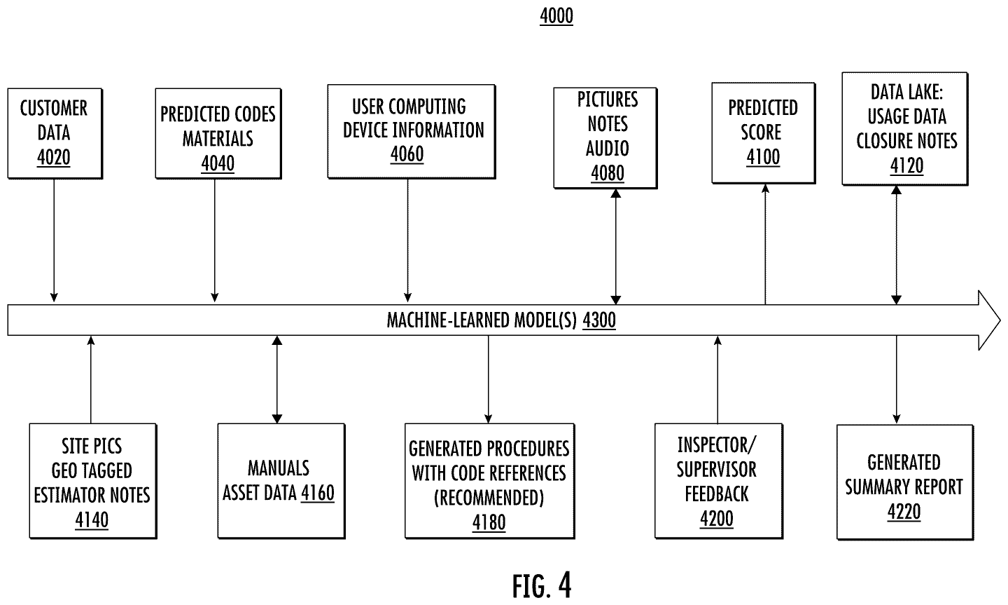

FIG. 4 is an example diagram which depicts an example exchange of information involving one or more machine-learned models, according to examples of the disclosure. Referring to FIG. 4, the one or more machine-learned models 4300 can correspond to the one or more machine-learned models 132 and/or the one or more machine-learned models 332 from FIG. 2A. For example, the one or more machine-learned models 4300 can receive various input information from various sources (e.g., user computing system 100, server computing system 300, third party computing system 500, etc.). For example, the input information may include customer data 4020, predicted codes and materials 4040, user computing device information 4060 (e.g., GPS data, compass information, LIDAR information, optical information, motion information, ultraviolet data, infrared data, audio data, images, videos, network information, etc.), images, notes, and audio information 4080, data lake information 4120 (e.g., usage data, closure notes, etc. which can be retrieved or transmitted from the data lake 3900), site information 4140 (e.g., project site imagery, geotagged information, estimator notes, etc.), manuals and asset data 4160, and feedback information 4200 (e.g., feedback information from an inspector and/or supervisor).

For example, at least some of the input information can be provided to the matching engine 1010 (e.g., one or more first machine-learned models) to identify one or more operators to perform the project. For example, at least some of the input information can be provided to the one or more code identification models 1020 (e.g., one or more second machine-learned models) to identify codes which are applicable to the project and/or the structure associated with the project. For example, at least some of the input information can be provided to the one or more computer vision algorithms 1030 (e.g., one or more third machine-learned models) to process the images to identify certain objects, structures, or materials which are included in the images which are associated with the project and/or structure. For example, at least some of the input information can be provided to the one or more code compliance models 1040 (e.g., one or more fourth machine-learned models) to generate project performance operations for performing the project. For example, at least some of the input information can be provided to the one or more code inspection models 1050 (e.g., one or more fifth machine-learned models) to generate inspection outcomes associated with the project and the structure.

For example, the one or more machine-learned models 4300 can output various output information from various sources (e.g., user computing system 100, server computing system 300, third party computing system 500, etc.). For example, the output information may include images, notes, and audio information 4080 (e.g., to assist an operator in performing the project performance operations), predicted score information 4100 (e.g., regarding a likelihood of passing an inspection), data lake information 4120 (e.g., information can be output to the data lake 3900 pertaining to the inspection outcome, project performance operations performed in association with completing the project, codes applicable to the project, operators involved in completing the project, etc.), manuals and asset data 4160 (e.g., updates to manuals and asset data associated with the project, recommended procedures with code references 4180 (e.g., project performance operations with applicable codes), and a generated summary report 4220.

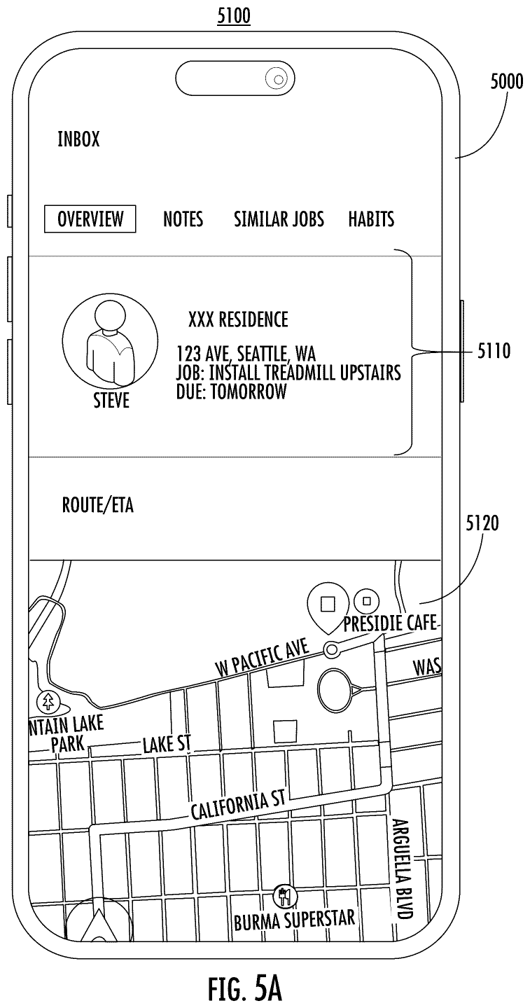

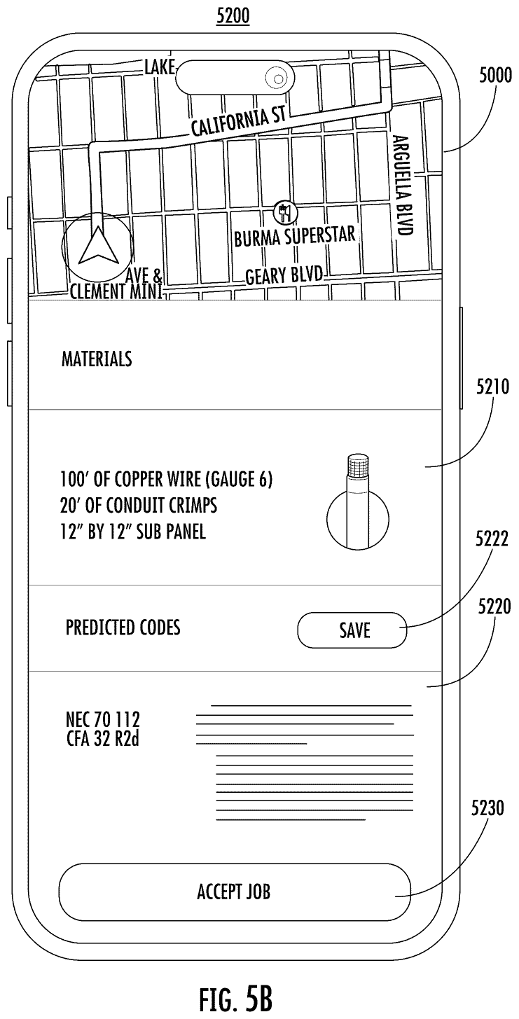

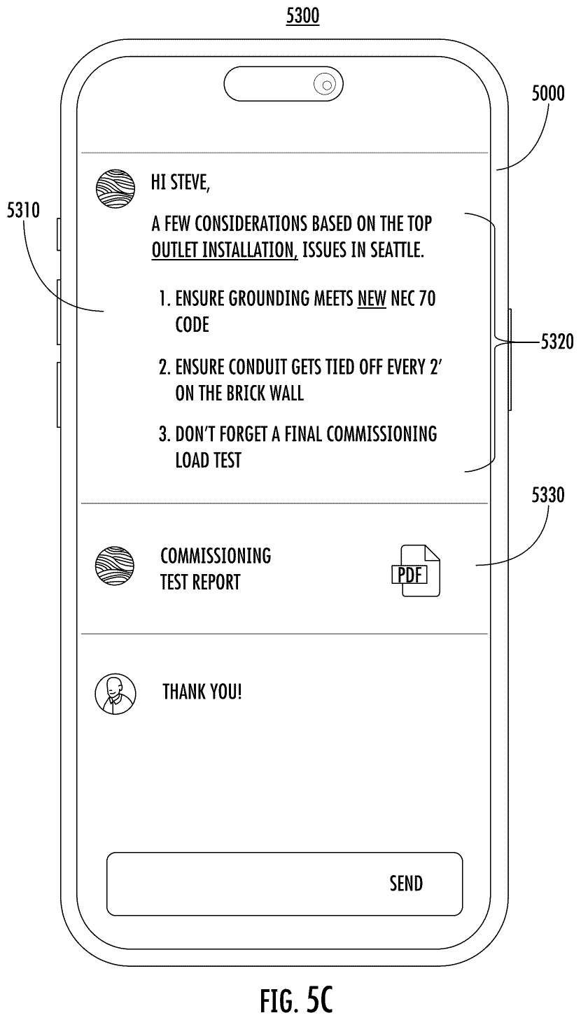

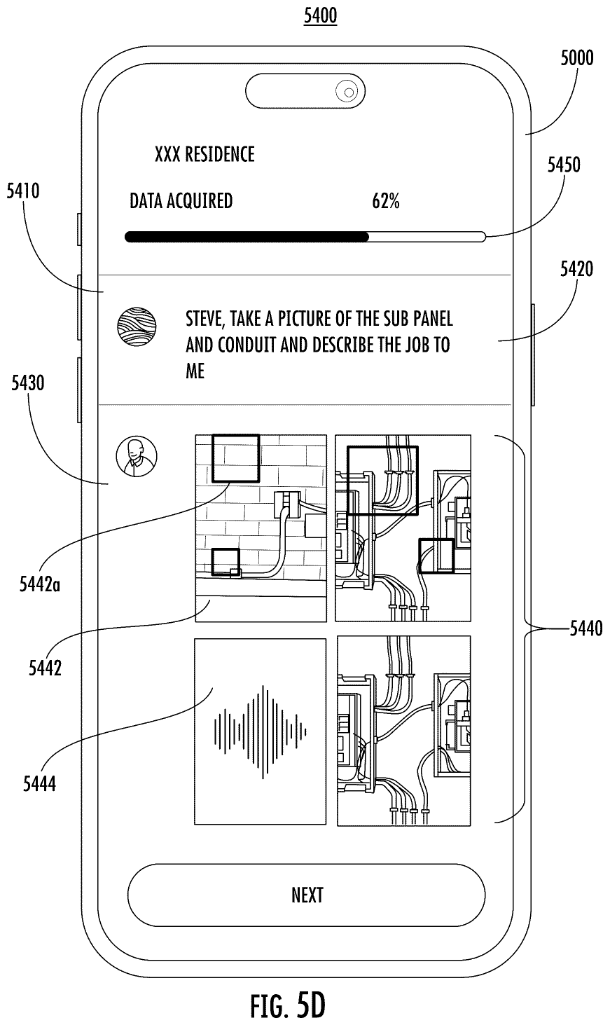

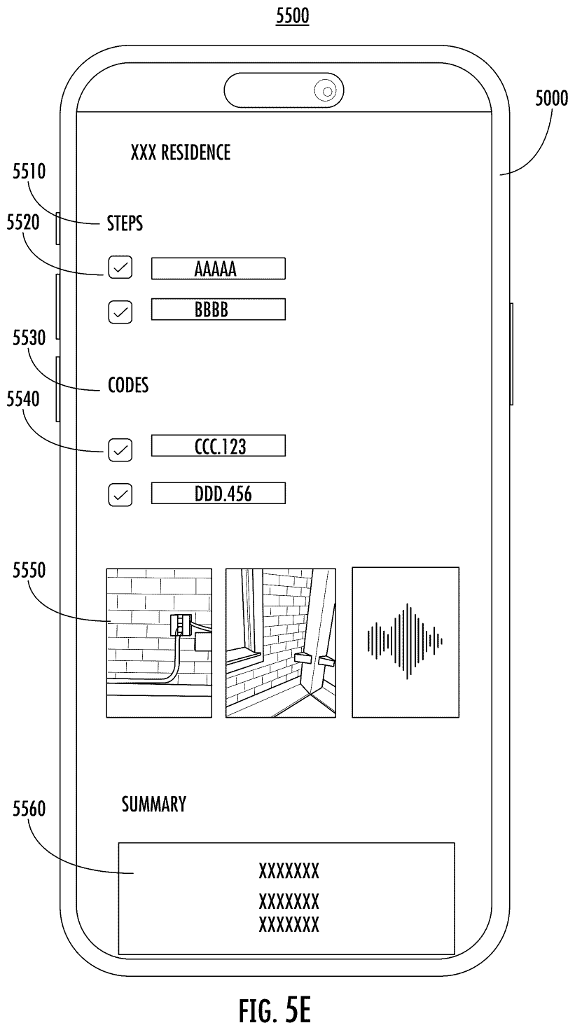

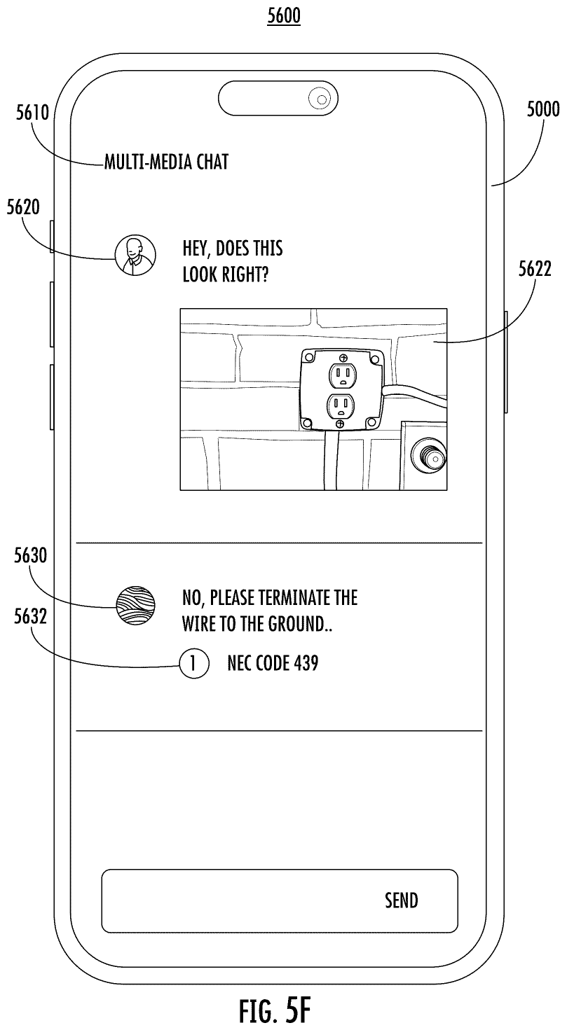

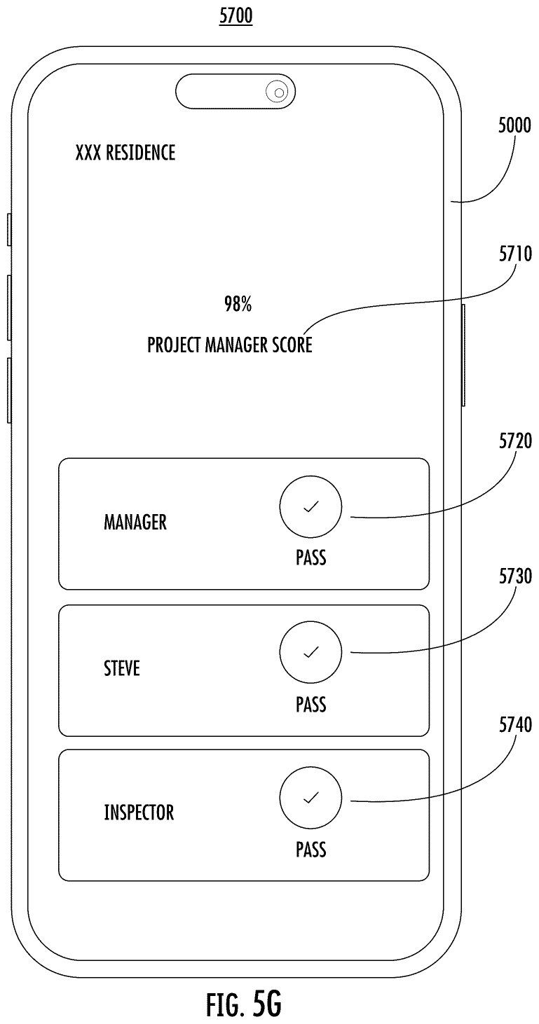

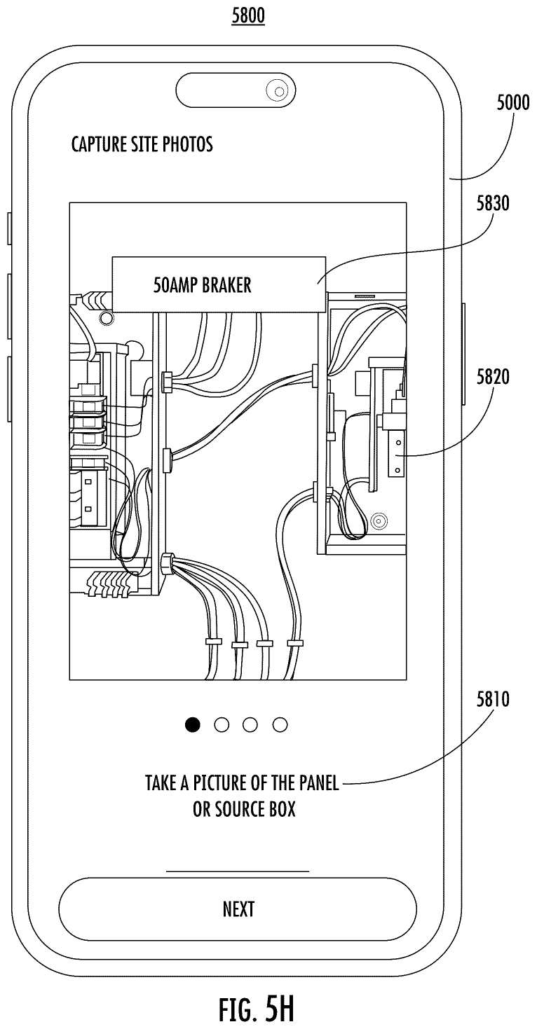

FIGS. 5A through 5I are example user interface screens which can be presented to a user for performing a project with respect to a structure, according to examples of the disclosure. For example, the example user interface screens may be provided as part of a project management application (e.g., part of an application system) that is stored or provided at a computing system (e.g., the user computing system 100 and/or server computing system 300).

Referring to FIG. 5A, the computing system (e.g., the user computing system 100 and/or server computing system 300) may be configured to provide for presentation on a display device of a user computing device 5000 a first user interface 5100 which can provide information to a user (e.g., an operator) regarding a project to be performed. For example, the user may be identified via the matching engine 1010 as an operator that is optimal or capable of performing the project. In some implementations, the user computing device 5000 can correspond to the user computing system 100. For example, in FIG. 5A the information may include project details 5110 which can include information regarding the property owner, an address, a description of the project, a timeline for completing the project, etc. The project details 5110 may be obtained from the project data (dispatch data), for example. For example, in FIG. 5A the information may include navigation information 5120 which can include a location of the project site, directions to the project site, etc.

Referring to FIG. 5B, the computing system (e.g., the user computing system 100 and/or server computing system 300) may be configured to provide for presentation on the display device a second user interface 5200 which can provide information to the user (e.g., the operator) regarding the project to be performed. For example, in FIG. 5B the information may include a first section 5210 which identifies materials which are needed for completing the project and a second section 5220 which identifies codes that are predicted to be applicable to the project. For example, the second user interface 5200 may include a first user interface element 5222 that can be selected to save the predicted codes. For example, the second user interface 5200 may include a second user interface element 5230 that can be selected to indicate that the user has accepted to perform the project.

Referring to FIG. 5C, the computing system (e.g., the user computing system 100 and/or server computing system 300) may be configured to provide for presentation on the display device a third user interface 5300 which can provide information to the user (e.g., the operator) regarding the project to be performed. For example, in FIG. 5C the third user interface 5300 may include a dialogue or chat feature 5310 by which the user and the computing system (e.g., via the one or more machine-learned models described herein) can exchange information. For example, the third user interface 5300 illustrates a first dialogue communication 5320 from the computing system which provides instructions to the user regarding how to perform the project performance operations (e.g., as determined by the one or more code compliance models 1040) in a manner that satisfies the codes applicable to the project (e.g., as determined by the one or more code identification models 1020). For example, the instructions may provide an indication (e.g., through underlining, highlighting, bolding, etc.) to notify or alert the user of revisions, changes, or updates to existing codes, or of new codes. For example, the third user interface 5300 illustrates a second dialogue communication 5330 from the computing system which includes a document related to the project (e.g., a commissioning test report).

Referring to FIG. 5D, the computing system (e.g., the user computing system 100 and/or server computing system 300) may be configured to provide for presentation on the display device a fourth user interface 5400 which can provide information to the user (e.g., the operator) regarding the project to be performed. For example, in FIG. 5D the fourth user interface 5400 may include a dialogue or chat feature 5410 by which the user and the computing system (e.g., via the one or more machine-learned models described herein) can exchange information. For example, the fourth user interface 5400 illustrates a first dialogue communication 5420 from the computing system which provides instructions to the user regarding how to perform a project performance operation (e.g., as determined by the one or more code compliance models 1040) associated with completing the project. For example, the user can provide the requested information as indicated by second dialogue communication 5430 which includes a plurality of media files 5440 (e.g., image files, video files, audio files, etc.) that can be provided (e.g., uploaded) to the computing system. For example, the plurality of media files 5440 include an image file 5442 which depicts a portion of the project site (e.g., a structure), and an audio file 5444 which can include a description of the project to be performed and/or a description of project performance operations which have been performed. In some implementations, the images can include indicators 5442a which identify particular objects or structures in the image. For example, in some implementations the user may manually modify or annotate the original captured image by indicating the object or structure of interest (e.g., via a bounding shape such as a bounding polygon or bounding box, via highlighting, etc.). For example, in some implementations the user computing device 5000 may be configured to automatically modify or annotate (e.g., via the one or more computer vision algorithms 1030) the original captured image by detecting the object or structure of interest and providing an indication or annotation to the object or structure of interest (e.g., via a bounding shape such as a bounding polygon or bounding box, via highlighting, etc.) before the images are sent to the computing system. For example, in some implementations the user computing device 5000 (e.g., the one or more computer vision algorithms 1030) may be configured to only transmit the detected object or structure of interest to the computing system (e.g., the one or more code compliance models 1040 and/or the one or more code inspection models 1050). In some implementations, the computing system (e.g., the one or more code inspection models 1050) can be configured to predict whether sufficient data or information is provided to be able to provide a prediction as to whether the project will pass inspection. For example, user interface element 5450 indicates that 62% of the information needed to provide the prediction as to whether the project will pass inspection is received.

Referring to FIG. 5E, the computing system (e.g., the user computing system 100 and/or server computing system 300) may be configured to provide for presentation on the display device a fifth user interface 5500 which can provide information to the user (e.g., the operator) regarding the project to be performed. For example, in FIG. 5E the fifth user interface 5500 may include project performance operations 5510 (steps) which describe operations to perform the project. In some implementations, the fifth user interface 5500 may include a first user interface element 5520 (e.g., a checkbox) that may be selectable so as to indicate whether a particular operation is completed or considered by the user. For example, in FIG. 5E the fifth user interface 5500 may include codes 5530 which are applicable to completing the project. In some implementations, the fifth user interface 5500 may include a second user interface element 5540 (e.g., a checkbox) that may be selectable so as to indicate whether a particular code is satisfied or considered by the user. For example, in FIG. 5E the fifth user interface 5500 may include images 5550 of the project site that can be provided by the user or from another entity. The one or more code compliance models 1040 may be configured to generate the project performance operations based on the images 5550 as well as based other information (e.g., the project data, applicable codes, detected objects, materials, and structures, etc.). For example, in FIG. 5E the fifth user interface 5500 may include a summary section 5560 which can summarize (e.g., textually and/or with imagery) the project performance operations, applicable codes, etc. The one or more code compliance models 1040 may be configured to generate the summary section 5560.

Referring to FIG. 5F, the computing system (e.g., the user computing system 100 and/or server computing system 300) may be configured to provide for presentation on the display device a sixth user interface 5600 which can provide information to the user (e.g., the operator) regarding the project to be performed. For example, in FIG. 5F the sixth user interface 5600 may include a dialogue or chat feature 5610 by which the user and the computing system (e.g., via the one or more machine-learned models described herein) can exchange information. For example, the sixth user interface 5600 illustrates a first dialogue communication 5620 from the user which asks the computing system whether a particular project performance operation has been completed correctly (e.g., that the particular project performance operation satisfies certain code requirements). In some implementations, the user may provide an image 5622 to the computing system. However, in some implementations the user can provide a video (e.g., in real-time while querying the computing system). For example, the sixth user interface 5600 illustrates a second dialogue communication 5630 from the computing system which provides a response to the user. In the example of FIG. 5F, the computing system indicates that the particular performance operation is performed incorrectly (does not satisfy code requirements). For example, the computing system may indicate the applicable code 5632 that is not satisfied and should be referenced by the user. For example, the one or more code inspection models 1050 may be configured to analyze the image 5622 to determine whether the code is satisfied. In some implementations, the one or more computer vision algorithms 1030 may be configured to detect objects, materials, structures, etc. in the image that can be used by the one or more code inspection models 1050 to determine whether the code is satisfied. The one or more computer vision algorithms 1030 can include one or more machine-learned models. The one or more code inspection models 1050 may be configured to generate one or more inspection outcomes based on the one or more images of the project site and/or structure and objects, materials, structures, materials, etc. which are detected in the one or more images of the structure by the one or more computer vision algorithms 1030. In some implementations, the one or more computer vision algorithms 1030 may transmit only the detected objects, materials, structures, materials, etc. to the one or more code inspection models 1050, rather than images having features that annotate or indicate the detected objects, materials, structures, materials, etc. Therefore, computer resources can be efficiently utilized and conserved. In some implementations, the one or more computer vision algorithms 1030 may transmit the images with annotations and/or indications which denote the detected objects, materials, structures, materials, etc. to the one or more code inspection models 1050.

Referring to FIG. 5G, the computing system (e.g., the user computing system 100 and/or server computing system 300) may be configured to provide for presentation on the display device a seventh user interface 5700 which can provide information to the user (e.g., the operator) regarding the project to be performed. For example, in FIG. 5G the seventh user interface 5700 may include a prediction score (project manager score) 5710 that indicates the likelihood the completed project (or completed project performance operation) will pass an inspection. For example, the seventh user interface 5700 illustrates a first user interface element 5720 which can indicate that the manager (supervisor) has provided (or is predicted to provide) an inspection outcome of pass or fail. For example, the seventh user interface 5700 illustrates a second user interface element 5730 which can indicate that the user (operator) has provided (or is predicted to provide) an inspection outcome of pass or fail. For example, the seventh user interface 5700 illustrates a third user interface element 5740 which can indicate that the inspector has provided (or is predicted to provide) an inspection outcome of pass or fail. For example, the one or more code inspection models 1050 may be configured to provide the prediction score and predicted inspection outcome.

Referring to FIG. 5H, the computing system (e.g., the user computing system 100 and/or server computing system 300) may be configured to provide for presentation on the display device an eighth user interface 5800 which can provide information to the user (e.g., the operator) regarding the project to be performed. For example, in FIG. 5H the eighth user interface 5800 may include instructions 5810 to capture an image of a project site (e.g., of a particular component, object, structure, etc.). In some implementations, the eighth user interface 5800 may be provided for presentation in response to the one or more code inspection models 1050 determining additional imagery is needed to determine whether a particular code is satisfied with respect to the project and/or structure. In some implementations, the eighth user interface 5800 may be provided for presentation in response to the one or more code compliance models 1040 determining the project performance operations to be performed so as to assist the user in taking appropriate images for determining whether a particular code is satisfied with respect to the project and/or structure. Instructing the user to take particular images of the project site and/or structure can increase efficiency of the inspection process and conserve computing resources (e.g., conserving memory by storing less images, conserving processing power by processing less images, conserving network resources and bandwidth by transmitting less images, etc.). The eighth user interface 5800 may include example image 5820 (e.g., stock imagery) of the project site (e.g., of the particular component, object, structure, etc.) for the user's reference when capturing the image. In some implementations, the example image 5820 may include an indication 5830 which is descriptive of a particular component (e.g., an annotation that describes the component, such as a 50 Amp breaker).

Referring to FIG. 5I, the computing system (e.g., the user computing system 100 and/or server computing system 300) may be configured to provide for presentation on the display device a ninth user interface 5900 which can provide information to the user (e.g., the operator) regarding the project to be performed. For example, in FIG. 5I the ninth user interface 5900 may include instructions 5910 to capture a video of a project site (e.g., of a particular component, object, structure, etc.). In some implementations, the ninth user interface 5900 may be provided for presentation in response to the one or more code inspection models 1050 determining one or more videos are needed to determine whether a particular code is satisfied with respect to the project and/or structure. In some implementations, the ninth user interface 5900 may be provided for presentation in response to the one or more code compliance models 1040 determining the project performance operations to be performed so as to assist the user in taking appropriate videos for determining whether a particular code is satisfied with respect to the project and/or structure. Instructing the user to take particular videos of the project site and/or structure can increase efficiency of the inspection process and conserve computing resources (e.g., conserving memory by storing less videos, conserving processing power by processing less videos, conserving network resources and bandwidth by transmitting less videos, etc.). The ninth user interface 5900 may include an example video screenshot 5920 (e.g., stock video screenshot) of the project site (e.g., of the particular component, object, structure, etc.) for the user's reference when capturing the video. In some implementations, the example video screenshot 5920 may include indications 5930, 5940, 5950 which are descriptive of a particular component, structure, or specification of the video to be captured (e.g., an annotation that describes the floor of the building in which the video is to be taken, a particular wall to be captured in the video, a particular distance of a structure to be captured on video, etc.).

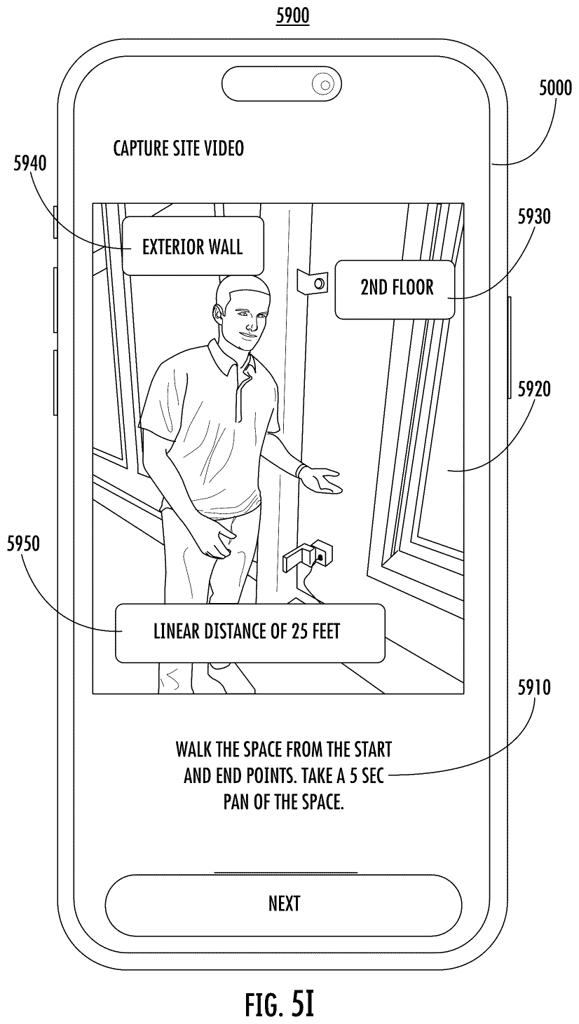

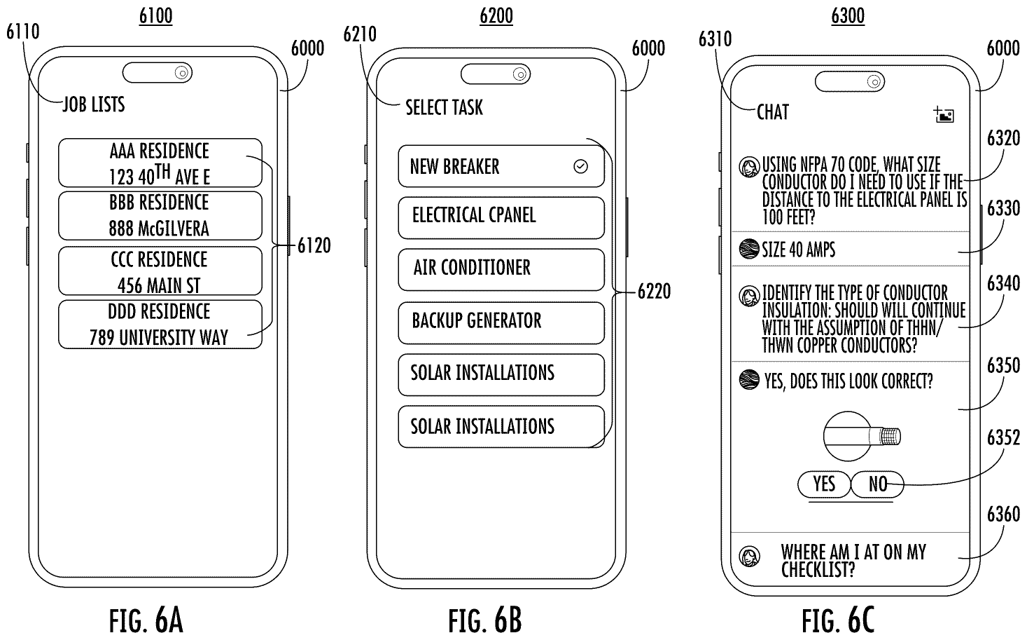

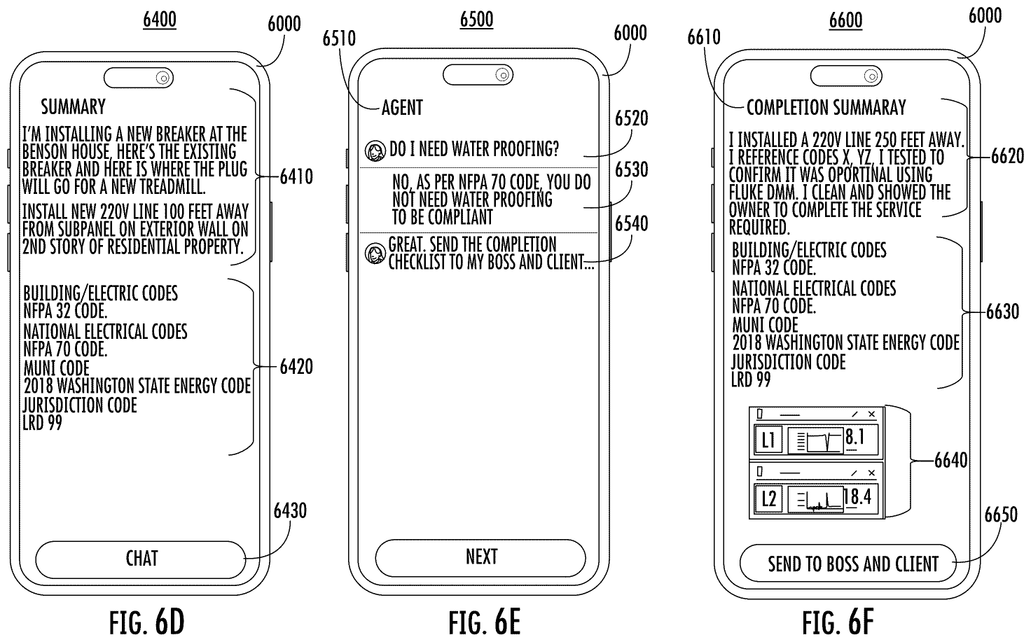

FIGS. 6A through 6F are example user interface screens which can be presented to a user for performing a project with respect to a structure, according to examples of the disclosure. For example, the example user interface screens may be provided as part of a project management application (e.g., part of an application system) that is stored or provided at a computing system (e.g., the user computing system 100 and/or server computing system 300).

Referring to FIG. 6A, the computing system (e.g., the user computing system 100 and/or server computing system 300) may be configured to provide for presentation on a display device of a user computing device 6000 a first user interface 6100 which can provide information to a user (e.g., an operator) regarding a project to be performed. For example, the first user interface 6100 may include a list of projects 6110 that include information relating to a plurality of projects 6120. In some implementations, the plurality of projects 6120 may include information (project data) relating to each project (e.g., a structure's location, which could be an address or a geolocation, information about the owner of the property, etc.). The list of projects 6110 can be presented to a candidate operator, for example. The candidate operator can be identified by the matching engine 1010, for example. The candidate operator can select one or more of the projects from among the plurality of projects 6120 (e.g., to confirm agreement to perform a project).

Referring to FIG. 6B, the computing system (e.g., the user computing system 100 and/or server computing system 300) may be configured to provide for presentation on the display device a second user interface 6200 which can provide information to the user (e.g., the operator) regarding the project to be performed. For example, in FIG. 6B the second user interface 6200 may include a list of selectable project performance operations (tasks) 6210 that may be associated with one or more projects for one or more structures. In the example of FIG. 6B, the second user interface 6200 includes a plurality of project performance operations 6220. The plurality of project performance operations 6220 may correspond to user interface elements which are selectable. For example, when one of the plurality of project performance operations 6220 is selected, the computing system (e.g., the one or more code compliance models 1040) may be configured to provide detailed instructions or guidance relating to the selected project performance operation.

Referring to FIG. 6C, the computing system (e.g., the user computing system 100 and/or server computing system 300) may be configured to provide for presentation on the display device a third user interface 6300 which can provide information to the user (e.g., the operator) regarding the project to be performed. For example, in FIG. 6C the third user interface 6300 may include a dialogue or chat feature 6310 by which the user and the computing system (e.g., via the one or more machine-learned models described herein) can exchange information. For example, the third user interface 6300 illustrates a first dialogue communication 6320 from the user requesting information regarding the project (e.g., information regarding how to perform a project performance operation in a manner that satisfies codes applicable to the project and/or structure). For example, the third user interface 6300 illustrates a second dialogue communication 6330 from the computing system which provides instructions to the user regarding how to perform the project performance operation (e.g., as determined by the one or more code compliance models 1040) in a manner that satisfies the codes applicable to the project (e.g., as determined by the one or more code identification models 1020). For example, the instructions may provide information responsive to a query from the user to assist the user in performing the project performance operation. The information can include identifying or confirming that the appropriate materials, tools, parts, etc., are being used to perform the project performance operations. The information can include step-by-step operations and guidance to perform particular project performance operations. For example, the third user interface 6300 illustrates a third dialogue communication 6340 from the user with another request for information regarding the project (e.g., information regarding how to perform a project performance operation in a manner that satisfies codes applicable to the project and/or structure). For example, the third user interface 6300 illustrates a fourth dialogue communication 6350 from the computing system which provides information to the user regarding how to perform the project performance operation (e.g., as determined by the one or more code compliance models 1040) in a manner that satisfies the codes applicable to the project (e.g., as determined by the one or more code identification models 1020). In the example of FIG. 6C, the fourth dialogue communication 6350 further includes a request for confirmation from the user regarding the project and/or structure (e.g., a confirmation concerning the conductor insulation). The request for confirmation can be implemented via user interface elements 6352 that are selectable by a user to respond to the computing system's request. For example, the third user interface 6300 illustrates a fifth dialogue communication 6360 from the user with another request for information regarding the project (e.g., information regarding the status of the project and the project performance operations). Thus, technical benefits can be achieved by the one or more machine-learned models of the computing system ensuring that codes applicable to the project are satisfied, ensuring that project performance operations are followed, avoiding the need for repeating work, preventing possible injuries or unsafe conditions associated with a project and/or structure, reducing the consumption of resources by ensuring proper materials are utilized, etc.

Referring to FIG. 6D, the computing system (e.g., the user computing system 100 and/or server computing system 300) may be configured to provide for presentation on the display device a fourth user interface 6400 which can provide information to the user (e.g., the operator) regarding the project to be performed. For example, in FIG. 6D the fourth user interface 6400 may include a summary section 6410 which includes a summary of the project performance operations associated with the project and/or structure. In some implementations, the one or more code compliance models 1040 may be configured to generate the summary section 6410 (e.g., based on the project data, identified codes, images of the project site, images with objects detected via the one or more computer vision algorithms 1030, etc.). For example, in FIG. 6D the fourth user interface 6400 may include a codes section 6420 which includes the codes applicable to the project and/or structure (e.g., as determined by the one or more code identification models 1020). For example, in FIG. 6D the fourth user interface 6400 may include a user interface element 6430 which, when selected, can execute a dialogue or chat feature by which the user and the computing system (e.g., via the one or more machine-learned models described herein) can exchange information relating to the project.

Referring to FIG. 6E, the computing system (e.g., the user computing system 100 and/or server computing system 300) may be configured to provide for presentation on the display device a fifth user interface 6500 which can provide information to the user (e.g., the operator) regarding the project to be performed. For example, in FIG. 6E the fifth user interface 6500 may include a dialogue or chat feature 6510 by which the user and the computing system (e.g., via the one or more machine-learned models described herein) can exchange information. For example, the fifth user interface 6500 illustrates a first dialogue communication 6520 from the user requesting information regarding the project (e.g., information regarding how to perform a project performance operation in a manner that satisfies codes applicable to the project and/or structure). For example, the fifth user interface 6500 illustrates a second dialogue communication 6530 from the computing system which provides instructions to the user regarding how to perform the project performance operation (e.g., as determined by the one or more code compliance models 1040) in a manner that satisfies the codes applicable to the project (e.g., as determined by the one or more code identification models 1020). For example, the instructions may provide information responsive to a query from the user to assist the user in performing the project performance operation. For example, the fifth user interface 6500 illustrates a third dialogue communication 6540 from the user confirming receipt of the information provided in the second dialogue communication 6530 and requesting that a project completion report be transmitted to one or more other entities (e.g., a supervisor, client, contractor, or other third party, etc.).

Referring to FIG. 6F, the computing system (e.g., the user computing system 100 and/or server computing system 300) may be configured to provide for presentation on the display device a sixth user interface 6600 which can provide information to the user (e.g., the operator) regarding the project to be performed. For example, in FIG. 6F the sixth user interface 6600 may include a project completion summary 6610 which can include a summary section 6620, a codes section 6630, a test results section 6640, etc. The summary section 6620 can include a textual summary, images, audio files, etc. which describes the project performance operations performed in association with the project and/or structure. The codes section 6630 can include the codes which were applicable to the project performance operations performed in association with the project and/or structure. The test results section 6640 can include information (e.g., electronic files) regarding tests which were performed during the project performance operations performed in association with the project and/or structure. In some implementations, the project completion summary 6610 may be generated by the one or more code inspection models 1050 (e.g., based on the images of the project site, the project data, applicable codes, images including detected objects, materials, and structures, information provided by the operator or other entity, etc.). For example, in FIG. 6F the sixth user interface 6600 may include a user interface element 6650 which, when selected, can electronically transmit the project completion report to one or more entities (e.g., a supervisor, client, inspector, contractor, third-party, etc.). In some implementations, the project completion summary 6610 may include additional information including inspection outcome information. For example, the inspection outcome information can include a prediction score (project manager score) that indicates the likelihood the completed project (or completed project performance operation) will pass or fail an inspection.

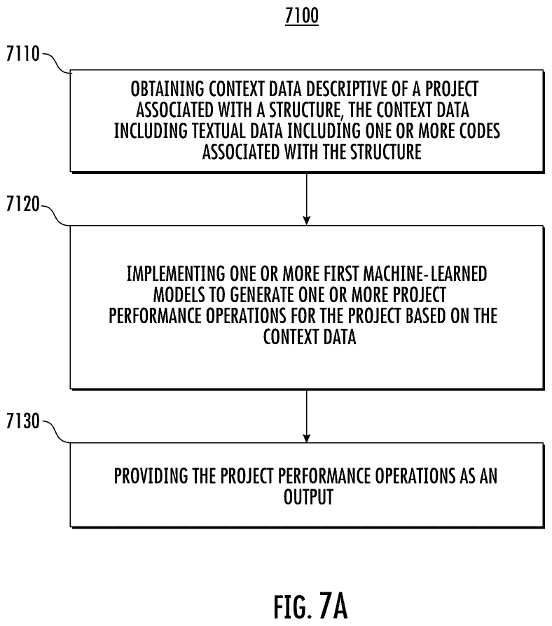

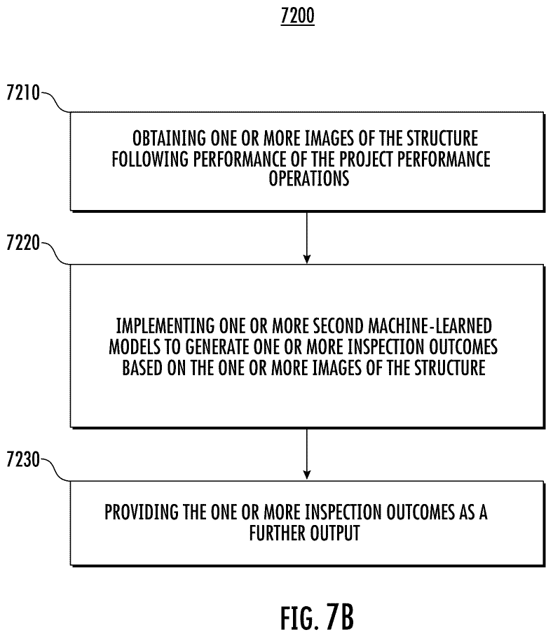

Examples of the disclosure are directed to computer implemented methods for performing a project, for ensuring codes applicable to a project and/or structure are satisfied, for determining whether a project is likely to pass inspection, for determining an appropriate operator for a project, etc., via one or more machine-learned models. FIGS. 7A and 7B are example computer-implemented methods for performing a project with respect to a structure, according to example embodiments of the disclosure.

The flow diagram of FIG. 7A illustrates a method 7100 for performing a project, by implementing one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 7A, at operation 7110 the method 7100 includes a computing device obtaining context data descriptive of a project associated with a structure, the context data including textual data including one or more codes associated with the structure. As described herein, the computing device may be embodied as user computing system 100, server computing system 300, or combinations thereof. For example, the context data can include one or more images that depict the project, structure, tools, parts, materials, etc. In some implementations, the one or more images can be captured by the user (e.g., via the image capturer 182).

In some implementations, the computing device can be configured to obtain project data that describes the project, identify the one or more codes that relate to the project based on the project data, and retrieve the one or more codes from a database (e.g., the code database 1022). For example, the project data can include location data associated with the project (e.g., the structure) and a textual description of the project. The project data can also include dispatch data which can include information regarding a project to be completed with respect to a structure (e.g., a building, an electrical panel, a generator, etc.). For example, the project data can specify a structure's location, which could be an address or a geolocation. The project data can include information about the owner of the property (e.g., language(s) spoken, pets owned, information about family members, availability, etc.), preferences of the owner (e.g., preferred hours, preferred operators or contractors, etc.). The project data can also include other information concerning the project, including an estimated time to perform the project, estimated materials needed to perform the project, estimated costs, permits needed for the project, equipment needed for the project, license requirements, bond requirements, etc.

In some implementations, the computing device may be configured to implement one or more machine-learned models (e.g., one or more code identification models 1020) to identify the one or more codes that relate to the project based on the project data.

In some implementations, the computing device may be configured to implement a matching engine to match the project with a human operator from among a plurality of human operators, based on the project data. In some implementations, the computing device may be configured to implement a matching engine to match the project with a machine operator from among a plurality of machine operators, based on the project data. For example, the matching engine may be implemented via one or more machine-learned models.

At operation 7120 the method 7100 includes the computing device implementing one or more machine-learned models to generate one or more project performance operations for the project based on the context data. For example, the one or more machine-learned models may include the one or more code compliance models 1040. For example, the one or more project performance operations can include operations for completing the project in compliance with the one or more codes. In some implementations, the one or more project performance operations for the project can be generated by the one or more first machine-learned models in response to the one or more images being captured by the user. In some implementations, the project performance operations and/or codes can be updated or revised based on the one or more images being captured by the user.

In some implementations, the computing device can obtain one or more images of the project site and/or structure. For example, the operator, a contractor, property owner, a third-party, etc. can capture the one or more images of the project site and/or structure. For example, the one or more computer vision algorithms 1030 can include one or more machine-learned models. The one or more computer vision algorithms 1030 may be configured to process the one or more images to identify (detect) certain objects, structures, materials, etc. which are included in the one or more images. The computing device may include one or more machine-learned models (e.g., the one or more code compliance models 1040) configured to generate the one or more project performance operations for the project based on the context data including the one or more codes, the project data, the one or more images of the project site and/or structure, and the objects, structures, materials, etc. detected in the one or more images by the one or more computer vision algorithms 1030. In some implementations, the one or more computer vision algorithms 1030 may transmit only the detected objects, materials, structures, materials, etc. to the one or more code compliance models 1040, rather than images having features that annotate or indicate the detected objects, materials, structures, materials, etc. Therefore, computer resources can be efficiently utilized and conserved. In some implementations, the one or more computer vision algorithms 1030 may transmit the images with annotations and/or indications which denote the detected objects, materials, structures, materials, etc. to the one or more code compliance models 1040.

At operation 7130 the method 7100 includes the computing device providing the project performance operations as an output. For example, the output may be provided for presentation via the display device 160 and/or the output device 170. For example, the output may be provided for presentation via a user interface.

The flow diagram of FIG. 7B illustrates a method 7200 for generating an inspection outcome, by implementing one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 7B, at operation 7210 the method 7200 includes a computing device obtaining one or more images of the project site and/or structure following performance of the project performance operations. As described herein, the computing device may be embodied as user computing system 100, server computing system 300, or combinations thereof.

At operation 7220 the method 7200 includes the computing device implementing one or more machine-learned models to generate one or more inspection outcomes based on the one or more images of the structure. For example, the one or more inspection outcomes can indicate one or more aspects of the structure that satisfy or do not satisfy the one or more codes. For example, the one or more inspection outcomes can indicate a likelihood of passing an inspection according to the one or more codes associated with the structure.

In some implementations, the one or more inspection outcomes can indicate a request for further information in association with one or more aspects of the structure that are not visible within the one or more images of the structure. For example, portions of the structure may not have been captured in images taken of the project site or may be hidden or obscured by other objects, or may be in a location in which it is not possible to capture an image of that particular portion of the structure. Therefore, the computing device (e.g., via the one or more code inspection models 1050) may be configured to provide an output (the request) for further information.

In some implementations, the request for further information can include outputting a request to a user to provide confirmation information associated with the one or more aspects of the structure that are not visible within the one or more images of the structure. In response to receiving the confirmation information, the computing device can implement one or more machine-learned models (e.g., the one or more code inspection models 1050) to re-generate the one or more inspection outcomes based on the one or more images and the confirmation information. For example, the user can confirm that a project performance operation was performed in a particular manner that satisfies codes associated with the project performance operation, that a particular tool, material, etc. used to perform a project performance operation satisfies codes, that a particular test result satisfies codes associated with the project performance operation, etc.

In some implementations, the request for further information can include outputting a request to a user to capture one or more images of the one or more aspects of the structure that are not visible within the one or more images of the structure. In response to receiving the one or more images of the one or more aspects of the structure the computing device can implement one or more machine-learned models (e.g., the one or more code inspection models 1050) to re-generate the one or more inspection outcomes based on the one or more images of the structure and the one or more images of the one or more aspects of the structure.

At operation 7230 the method 7200 includes the computing device providing the one or more inspection outcomes as an output. For example, the output may be provided for presentation via the display device 160 and/or the output device 170. For example, the output may be provided for presentation via a user interface.

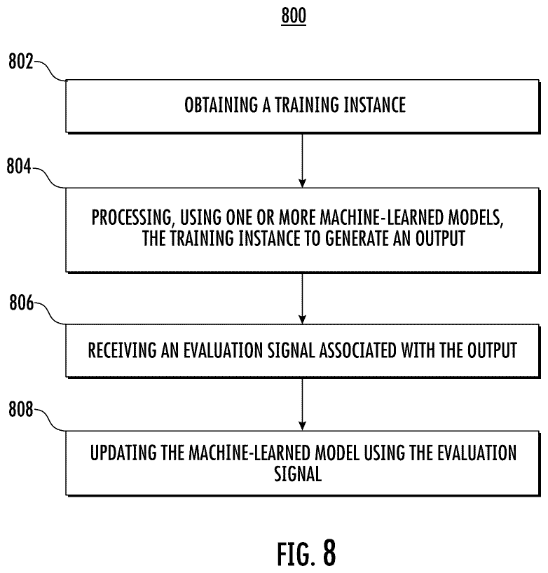

Referring now to FIG. 8, depicted is a flowchart diagram of an example method 800 for training one or more machine-learned models. The method 800 can facilitate the iterative process of refining a machine-learned model to improve its performance in generating predictions based on input data. The method 800 can be implemented by a computing system that includes one or more computing devices, which can execute the steps of the method 800 using one or more machine-learned models stored in memory.

At 802, the method 800 can include obtaining a training example. This training example can be a piece of data or a set of data used to train the machine-learned model. Training examples can be sourced from various datasets, such as a training dataset, a validation dataset, or a testing dataset, and can be labeled or unlabeled, depending on the learning paradigm employed (e.g., supervised, unsupervised, semi-supervised, or reinforcement learning).

At 804, the method 800 can include processing the training example to generate a prediction. This step can involve using one or more machine-learned models to analyze the training example and produce an output. The output can be a direct prediction from the machine-learned model or can result from a sequence of processing operations that include the model's output. The processing can leverage various machine learning techniques, such as neural networks, decision trees, or support vector machines, to interpret the training example and derive a prediction.

At 806, the method 800 can include receiving an evaluation signal (e.g., loss signal) associated with the prediction. The loss signal can be computed using a loss function that measures the discrepancy between the predicted output and the ground truth or expected output. Different types of loss functions can be utilized, such as mean squared error for regression tasks or cross-entropy loss for classification tasks. The loss signal provides feedback on the accuracy of the prediction, which can be used to adjust the parameters of the machine-learned model.

At 808, the method 800 can include updating the machine-learned model using the loss signal. This operation can involve adjusting the values of the model's parameters to minimize the loss signal, thereby improving the model's predictive capability. Techniques such as gradient descent or backpropagation can be employed to iteratively update the parameters based on the gradient of the loss signal with respect to the parameter values. This updating process can be performed over multiple training iterations, with the objective of converging to a set of parameter values that yield the best performance of the model on the training data.

The method 800 can be part of a larger training procedure that includes pre-training, fine-tuning, and potentially refining the model with user feedback. Pre-training can involve training the model on a large-scale dataset to establish a broad performance base, while fine-tuning can focus on smaller-scale training on higher-quality data. User feedback can further refine the model's performance by incorporating real-world usage data and human evaluations.

In some implementations, the method 800 can be adapted to various stages of model training, allowing for flexibility in the training process. For instance, certain portions of the machine-learned model can be “frozen” during fine-tuning to retain information learned from broader domains, or the method 800 can be implemented for specific tasks such as online training or reinforcement learning based on runtime inferences.

Overall, the method 800 provides a structured approach to training machine-learned models, enabling the iterative improvement of model performance through the acquisition of training examples, processing to generate predictions, receiving loss signals, and updating the model parameters. This structured training process can enhance the ability of machine-learned models to accurately predict outcomes and generalize to new, unseen data.

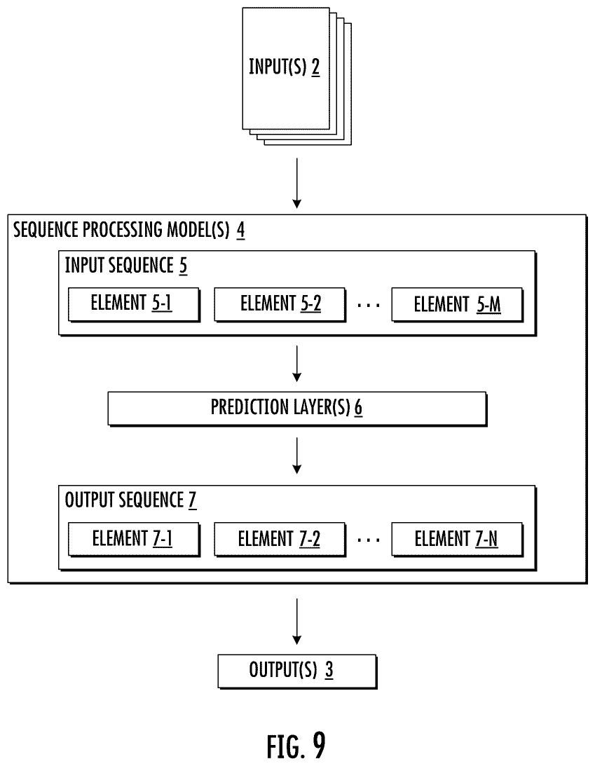

Referring now to FIG. 9, a block diagram illustrates an example implementation of a sequence processing model(s) 4 configured to process sequences of information. The sequence processing model(s) 4 can receive input(s) 2, which may include a variety of data types such as text, images, audio, or other forms of data. These input(s) 2 are then processed to obtain an input sequence 5, which is a representation of the data in a format understood by the sequence processing model(s) 4.

Sequence processing model(s) 4 can include one or multiple machine-learned model components configured to ingest, generate, or otherwise reason over sequences of information. For example, some example sequence processing models in the text domain are referred to as “Large Language Models,” or LLMs. Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, biochemical domains, by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

The input sequence 5 comprises a series of input elements, denoted as element 5-1, element 5-2, . . . , through element 5-M, where M represents the total number of elements in the input sequence 5. Each element within input sequence 5 can represent discrete or continuously distributed data points within an embedding space, capturing the essential information conveyed by input(s) 2.

The sequence processing model(s) 4 further include prediction layer(s) 6, which can process the input sequence 5 to generate an output sequence 7. The prediction layer(s) 6 are composed of one or more machine-learned model architectures that manipulate and transform the input elements to extract higher-order meaning and relationships between them. This transformation allows for the prediction of new output elements based on the context provided by the input sequence 5.

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Output sequence 7 is generated from prediction layer(s) 6 and includes a series of output elements, labeled as element 7-1, element 7-2, . . . , through element 7-N, where N represents the total number of elements in the output sequence 7. These output elements can be the result of autoregressive generation, where each likely next output element is sampled and added to the context window for subsequent predictions. Alternatively, output sequence 7 can be generated non-autoregressively, predicting multiple output elements together without sequential conditioning.

The system can then generate output(s) 3 based on the output sequence 7. These output(s) 3 can be utilized in various applications, such as content generation, classification, or instruction implementation, depending on the nature of the input(s) 2 and the configuration of the sequence processing model(s) 4.

In some implementations, sequence processing model(s) 4 can be adapted for specific tasks or data domains. For instance, sequence processing model(s) 4 can be configured to process textual input for natural language understanding tasks or image-based input for visual recognition tasks. The flexibility of sequence processing model(s) 4 allows them to handle multimodal input sequences, facilitating information extraction and reasoning across diverse data modalities.

Alternative implementations may include sequence processing model(s) 4 with different configurations of prediction layer(s) 6, such as transformer-based architectures, recurrent neural networks (RNNs), long short-term memory (LSTM) models, or convolutional neural networks (CNNs). These various architectures can enable sequence processing model(s) 4 to understand or generate sequences of information that are tailored to the specific requirements of the application at hand.

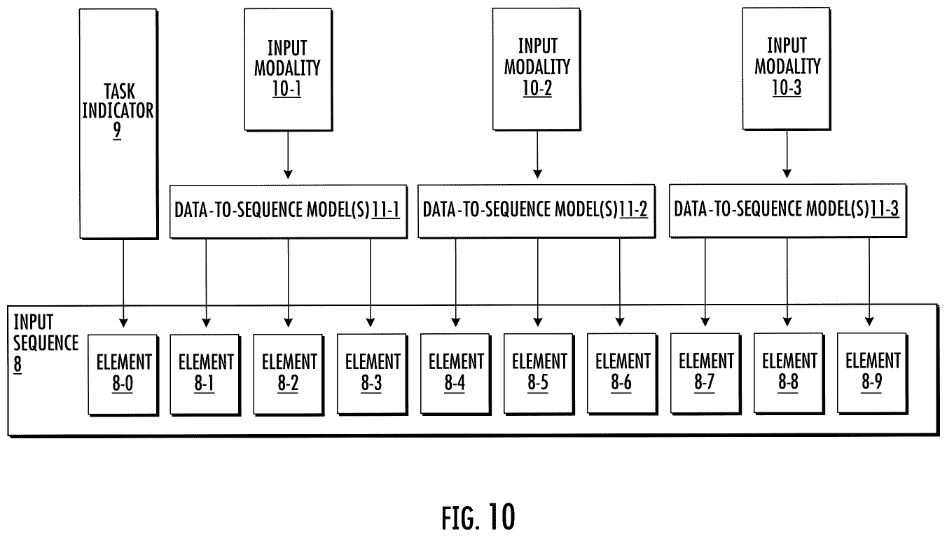

Referring now to FIG. 10, a block diagram illustrates an example implementation of a multi-modal sequence processing model that can populate an input sequence 8. Central to this implementation is the task indicator 9, which can provide a signal to the model(s) processing the input sequence 8, indicating the specific task being performed. This task indicator 9 can include a model or component configured to identify a particular task and inject a corresponding input value into the input sequence 8, represented by element 8-0. The input value can be a learned representation within a continuous embedding space, signaling to the model(s) the nature of the task at hand.

The system further includes various input modalities, such as input modality 10-1, input modality 10-2, and input modality 10-3, each associated with different data types. For instance, input modality 10-1 might represent textual data, input modality 10-2 might represent image data, and input modality 10-3 might represent audio data. Each input modality can provide a unique set of data that contributes to the multimodal nature of the input sequence 8.

Data-to-sequence models, specifically data-to-sequence model(s) 11-1, data-to-sequence model(s) 11-2, and data-to-sequence model(s) 11-3, are adapted to project data from their respective input modalities into a format compatible with the input sequence 8. These models can transform the data to obtain elements 8-1, 8-2, 8-3, etc., for input modality 10-1; elements 8-4, 8-5, 8-6, etc., for input modality 10-2; and elements 8-7, 8-8, 8-9, etc., for input modality 10-3. The elements within input sequence 8 can indicate specific locations within a multidimensional embedding space, mapping to discrete or continuously distributed locations depending on the nature of the data.

In some implementations, the data-to-sequence models 11-1, 11-2, and 11-3 can be trained jointly or independently from the machine-learned sequence processing model(s) 4 to facilitate end-to-end training. These models can form part of the machine-learned sequence processing model(s) 4 illustrated in FIG. 9, enhancing the system's ability to extract and reason over information from diverse data modalities.

The input sequence 8, as depicted in FIG. 10, represents a multimodal input sequence that contains elements from different data modalities using a common dimensional representation. This enables the system to process and reason over a variety of data types, facilitating complex tasks such as information extraction, content generation, or decision-making processes. The elements within input sequence 8, such as elements 8-0 through 8-9, can be processed by subsequent components of the system. For example, with reference to FIG. 9, the input sequence 8 from FIG. 10 can be processed with the prediction layer(s) 6, to generate an output sequence that can drive the generation of output(s) 3 based on the processed multimodal data.

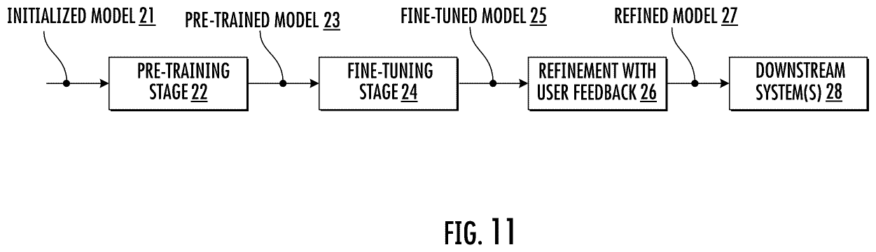

Referring now to FIG. 11, an example training flow for training a machine-learned model is depicted. The training flow illustrates the progression of a model through various stages, beginning with an initialized model 21 and culminating in a refined model 27 that can be output to downstream system(s) 28 for deployment or further development.

The initialized model 21 represents the starting point of the training process. This model can be in an initial state, with weight values that are either randomly assigned or based on an initialization schema. In some cases, the initial weight values can be derived from prior pre-training for the same or different models, providing a foundation upon which further training can be built.

The pre-training stage 22 signifies the initial phase of training, where the initialized model 21 undergoes large-scale training over potentially noisy data to achieve a broad base of performance levels across various tasks or data types. Pre-training stage 22 can be implemented using one or more pre-training pipelines that operate over data from dataset(s). This stage can be omitted if the initialized model 21 is already pre-trained, such as when the model contains, is, or is based on a pre-trained foundational model or an expert model.

Upon completion of the pre-training stage 22, the model transitions to a pre-trained model 23. This model can then undergo fine-tuning in the fine-tuning stage 24, where smaller-scale training is conducted on higher-quality data, such as labeled or curated datasets. Fine-tuning stage 24 can be facilitated by one or more fine-tuning pipelines, which refine the performance of pre-trained model 23 to meet specific performance criteria or to adapt to a narrower domain present in the fine-tuning dataset(s).

The fine-tuned model 25 represents the outcome of fine-tuning stage 24, which can then be subjected to refinement with user feedback 26. This stage involves incorporating feedback from human users to further enhance the model's performance. Refinement with user feedback 26 can include reinforcement learning techniques and can be based on human feedback on the model's performance during use.

The refined model 27 emerges from the refinement with user feedback 26 as an updated version of development model 16, which can then be output to downstream system(s) 28. Downstream system(s) 28 can be any system or platform where the refined model 27 is deployed for practical application or further development.

Overall, FIG. 11 provides a structured representation of the training flow for a machine-learned model, outlining the systematic approach to evolving the model from an initial state to a fully refined state ready for practical application or further development.

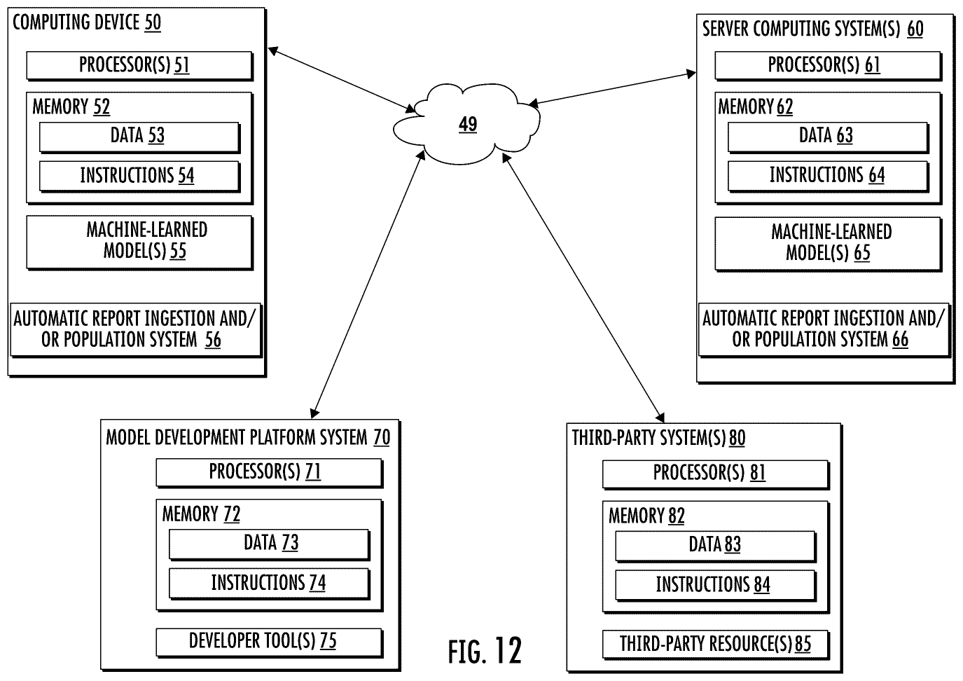

Referring now to FIG. 12, a block diagram is presented that illustrates an example networked computing system capable of performing various aspects of the disclosed machine learning-based report completion techniques. The system includes a plurality of computing devices and systems that are interconnected via a network, facilitating cooperative interactions to execute the disclosed methods.

The example computing device 50 can represent a diverse range of computing devices, such as personal computing devices, mobile devices, or server computing devices. Computing device 50 includes one or more processors 51, which can be any suitable processing device such as a microprocessor or a controller. These processors 51 can execute data 53 and instructions 54 stored in memory 52 to perform operations that implement features of the present disclosure. Memory 52 can be a non-transitory computer-readable storage medium, such as RAM or flash memory devices.

Computing device 50 can also include machine-learned models 55, which can be loaded into memory 52 and utilized by processors 51 for various tasks, such as drafting patent applications or training on patent-related data. These machine-learned models 55 can be developed locally on computing device 50 or received from other systems like server computing system(s) 60.

Server computing system(s) 60 can mirror the structure of computing device 50, comprising processors 61 and memory 62 that store data 63 and instructions 64. Server computing system(s) 60 can also include machine-learned models 65, which can be the same as or different from machine-learned models 55 on computing device 50. These machine-learned models 65 can be used to host or serve model inferences for client devices, potentially implementing machine-learned models in a client-server relationship.

Network 49 serves as the communication medium that enables data exchange between computing device 50 and server computing system(s) 60. Network 49 can be any type of communications network, such as the internet, and can support various communication protocols and encodings to facilitate secure and efficient data transmission.

In some implementations, computing device 50 and server computing system(s) 60 can operate in a distributed computing environment, where server computing system(s) 60 manage the implementation of machine-learned models 65, and computing device 50 acts as a client device accessing the services provided by server computing system(s) 60. This configuration can allow for remote performance of inference and training operations, with outputs returned to computing device 50 for further use or analysis.

The server computing system(s) 60 and/or the computing device 50 can include and collaboratively operate to implement an automatic report ingestion and/or population system as described herein. For example, some or all of the automatic report ingestion and/or population system can be implemented by the server computing system(s) 60 (e.g., shown at population system 66). For example, the server computing system(s) 60 can implement the automatic report ingestion and/or population system 66 as a web application or software as a service. Additionally, or alternatively, some or all of the automatic report ingestion and/or population system can be implemented by the computing device 50 (e.g., shown at population system 56). For example, the computing device 50 can implement the automatic report ingestion and/or population system 56 using locally stored and executed computer code (e.g., software). Thus, server computing system(s) 60 and/or the computing device 50 can include and execute computer instructions stored on computer-readable media to implement the systems and methods described herein.

The disclosed networked computing system exemplifies a versatile and scalable platform for implementing the advanced machine learning techniques described herein. By leveraging the interconnected nature of the computing devices and systems, the disclosed methods can be executed in a manner that optimizes resource utilization and maximizes the capabilities of the machine-learned models.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer-implemented method, comprising:
obtaining, by a computing device comprising one or more processors, context data descriptive of a project associated with a structure, the context data including textual data including one or more codes associated with the structure;
implementing, by the computing device, one or more first machine-learned models to generate one or more project performance operations for the project based on the context data, wherein the one or more project performance operations include operations for completing the project in compliance with the one or more codes; and
providing, by the computing device, the one or more project performance operations as an output.

2. The computer-implemented method of claim 1, wherein
the context data further includes one or more images of the structure,
the one or more images are captured by a user, and
the one or more project performance operations for the project are generated by the one or more first machine-learned models in response to the one or more images being captured by the user.

3. The computer-implemented method of claim 1, wherein obtaining, by the computing device comprising the one or more processors, the context data descriptive of the project associated with the structure comprises:
obtaining, by the computing device, project data that describes the project;
identifying, by the computing device, the one or more codes that relate to the project based on the project data; and
retrieving, by the computing device, the one or more codes from a database.

4. The computer-implemented method of claim 3, wherein the project data comprises location data associated with the structure and a textual description of the project.

5. The computer-implemented method of claim 3, wherein identifying, by the computing device, the one or more codes that relate to the project based on the project data comprises implementing, by the computing device, one or more second machine-learned models to identify, based on the project data, the one or more codes that relate to the project.

6. The computer-implemented method of claim 1, further comprising:
obtaining, by the computing device, one or more images of the structure following performance of the project performance operations;
implementing, by the computing device, one or more second machine-learned models to generate one or more inspection outcomes based on the one or more images of the structure; and
providing, by the computing device, the one or more inspection outcomes as another output.

7. The computer-implemented method of claim 6, wherein the one or more inspection outcomes indicate one or more aspects of the structure that satisfy or do not satisfy the one or more codes.

8. The computer-implemented method of claim 6, wherein the one or more inspection outcomes indicate a request for further information in association with one or more aspects of the structure that are not visible within the one or more images of the structure.

9. The computer-implemented method of claim 8, wherein the request for further information includes outputting a request to a user to provide confirmation information associated with the one or more aspects of the structure that are not visible within the one or more images of the structure, and
the method further comprises, in response to receiving the confirmation information, implementing, by the computing device, the one or more second machine-learned models to re-generate the one or more inspection outcomes based on the one or more images and the confirmation information.

10. The computer-implemented method of claim 8, wherein the request for further information includes outputting a request to a user to capture one or more images of the one or more aspects of the structure that are not visible within the one or more images of the structure; and
the method further comprises, in response to receiving the one or more images of the one or more aspects of the structure, implementing, by the computing device, the one or more second machine-learned models to re-generate the one or more inspection outcomes based on the one or more images of the structure and the one or more images of the one or more aspects of the structure.

11. The computer-implemented method of claim 6, wherein the one or more inspection outcomes indicate a likelihood of passing an inspection according to the one or more codes associated with the structure.

12. The computer-implemented method of claim 6, further comprising:
implementing, by the computing device, one or more third machine-learned models to detect one or more objects in the one or more images of the structure, and
the one or more second machine-learned models generate the one or more inspection outcomes based on the one or more images of the structure and the one or more objects detected in the one or more images of the structure.

13. The computer-implemented method of claim 1, further comprising:
obtaining, by the computing device, one or more images of the structure; and
implementing, by the computing device, one or more second machine-learned models to detect one or more objects in the one or more images of the structure, and
the one or more first machine-learned models generate the one or more project performance operations for the project based on the context data including the one or more codes, the one or more images of the structure, and the one or more objects detected in the one or more images of the structure.

14. The computer-implemented method of claim 1, wherein obtaining, by the computing device comprising the one or more processors, the context data descriptive of the project associated with the structure comprises:
obtaining, by the computing device, project data that describes the project, and the method further comprises:
implementing, by the computing device, one or more second machine-learned models to match the project with an operator from among a plurality of operators, based on the project data.

15. A computing device, comprising:
one or more memories configured to store instructions; and
one or more processors configured to execute the instructions to perform operations, the operations comprising:
obtaining context data descriptive of a project associated with a structure, the context data including textual data including one or more codes associated with the structure;
implementing one or more first machine-learned models to generate one or more project performance operations for the project based on the context data, wherein the one or more project performance operations include operations for completing the project in compliance with the one or more codes; and
providing the one or more project performance operations as an output.

16. The computing device of claim 15, wherein obtaining the context data descriptive of the project associated with the structure comprises:
obtaining project data that describes the project, and
the operations further comprise:
implementing one or more second machine-learned models to identify the one or more codes that relate to the project based on the project data.

17. The computing device of claim 16, wherein the operations further comprise:
implementing one or more third machine-learned models to match the project with an operator from among a plurality of operators, based on the project data.

18. The computing device of claim 17, wherein the operations further comprise:
capturing one or more first images of the structure;
implementing one or more fourth machine-learned models to detect one or more objects, structures, or materials within the one or more first images; and
implementing the one or more first machine-learned models to generate the one or more project performance operations for the project is further based on the one or more first images of the structure and the one or more objects, structures, or materials detected by the one or more fourth machine-learned models within the one or more first images.

19. The computing device of claim 18, wherein the operations further comprise:
capturing one or more second images of the structure following completion of the one or more project performance operations;
implementing the one or more fourth machine-learned models to detect one or more objects, structures, or materials within the one or more second images;
implementing one or more fifth machine-learned models to generate one or more inspection outcomes based on the context data including the one or more codes and the project data, the one or more second images of the structure, and the one or more objects, structures, or materials detected by the one or more fifth machine-learned models within the one or more second images; and
providing the one or more inspection outcomes as another output.

20. A non-transitory computer readable medium storing instructions which, when executed by a processor, cause the processor to perform operations, the operations comprising:
obtaining context data descriptive of a project associated with a structure, the context data including textual data including one or more codes associated with the structure;
implementing one or more first machine-learned models to generate one or more project performance operations for the project based on the context data, wherein the one or more project performance operations include operations for completing the project in compliance with the one or more codes; and
providing the one or more project performance operations as an output.
